(19) United States
(12) Patent Application Publication
(10) Pub. No.: US 2026/0250171 A1
(43) Pub. Date: Aug. 27, 2026

(54) SELF-MEDIATED SALTLESS WHOLE HOME WATER TREATMENT SYSTEMS AND METHODS

(71) Applicant: Pentair Residential Filtration, LLC, Brookfield, WI (US)

(72) Inventors: Blake Brewer, Eden Prairie, MN (US); Charles Bulger, Falcon Heights, MN (US); John Jerome Haigh, Menomonee Falls, WI (US); Eric Wehrli, Milwaukee, WI (US)

(21) Appl. No.: 19/281,390

(22) Filed: Jul. 25, 2025

Related U.S. Application Data
(60) Provisional application No. 63/761,763, filed on Feb. 21, 2025.

(51) Int. Cl. C02F 9/00; C02F 1/00; C02F 1/44

(52) U.S. Cl. CPC C02F 9/00; C02F 1/001; C02F 1/441; C02F 2201/005; C02F 2201/006; C02F 2209/40; C02F 2209/445

(57) ABSTRACT

The present disclosure provides a water treatment system including a processor subsystem and a tank subsystem. The tank stores prefiltered water from a carbon filter in a bottom portion of the tank and mineralized water from a post-filtration subsystem in a top portion of the tank. The tank is configured to supply an outlet with the mineralized water before the second prefiltered water.

### CROSS-REFERENCE TO RELATED APPLICATIONS

This application claims priority to U.S. Provisional Patent Application Ser. No. 63/761,763, filed on Feb. 21, 2025, entitled “SELF-MEDIATED SALTLESS WHOLE HOME WATER TREATMENT SYSTEMS AND METHODS,” currently pending, the entire disclosure of which is incorporated herein by reference.

### FIELD OF DISCLOSURE

The present disclosure relates generally to a water treatment system for softening water for use in a residential or a commercial application, more specifically to various self-mediated saltless whole home water treatment systems and methods designed to balance water hardness and remove chemicals of concern from the water.

### BACKGROUND

Hard water, which is water that contains a high concentration of mineral ions, is a common problem. The most common mineral ions found in hard water are calcium and magnesium, although other metals such as iron, aluminum, manganese, lead, and copper may also be found in hard water. According to the American National Standards NSF/ANSI 44 and NSF/ANSI 330, measured water hardness values of 1 grain per gallon (or 17.1 milligrams per liter) or higher is indicative of hard water. Water may be characterized based on various levels of hardness as shown in Table 1 below.

TABLE 1

| GRAINS PER | MILLIGRAMS | WATER |
|---|---|---|
| GALLON | PER LITER | HARDNESS |
| Less than 1 | Less than 17.1 | Soft |
| 1-3.5 | 17.1-60 | Slightly Hard |
| 3.5-7 | 60-120 | Moderately Hard |
| 7-10 | 120-180 | Hard |
| Over 10 | Over 180 | Very Hard |

The use of hard water can cause several issues including, among others: dry skin and hair, strange odor or taste to water, dingy cloths, spots on dishes, low water pressure, scale deposits in plumbing and bathroom fixtures, and/or premature appliance breakdown.

Currently, several technologies are available to soften hard water for use in residential or commercial properties. The most common water softening technology is a resin water softener system, which uses an ion exchange resin to remove hard water minerals such as calcium and magnesium from the water. In a resin water softener system, resin beads are placed inside a tank of the water softener system to form a “bed”. Over time, however, the resin bed becomes saturated with the exchanged hardness ions. To regenerate the resin bed for repeated use, a monovalent salt or brine must be added to the tank to flush out the saturated ions. The regenerated water is drained out of the softener tank and the resin is then ready for reuse.

While resin-based water softeners are effective at removing hardness from water, there are several disadvantages. First, the resin bed needs to be regenerated for repeated use to remove hardness from the water, which increases maintenance costs. Second, resin-based systems require additional water for flushing the resin bed during the regeneration process and a drain for removing the regenerated water; thus, wastewater is produced.

Another technology that may be used to combat hard water is template assisted crystallization (TAC) technology. However, TAC technology is a water conditioning technology and does not soften water. More specifically, TAC systems do not remove calcium and magnesium ions from water. Rather, they provide nucleation sites that induce the formation of microscopic crystals of calcium and magnesium, the microscopic crystals then freely pass through the media and do not readily attach to pipes or appliances.

The benefits of TAC technology include that such systems do not need to be regenerated with salt and do not need to be connected to a drain for flushing out retentate water as with resin water softening systems. One disadvantage of TAC water conditioners is that they are not well suited for extremely hard water. Resin water softeners are currently the best option for softening extremely hard water. In addition, TAC water conditioners do not remove iron. Thus, TAC water conditioners require an iron purifier to remove iron from hard water. TAC water conditioners also still allow for some hard water to form scale, though only in small amounts. Finally, the benefits to skin, hair, clothing, and dishes are also negligible with TAC systems.

To meet environmental regulations and customer demand for meaningful saltless water softening, desalination membrane technology has been developed for softening water for residential and commercial use. In particular, Reverse Osmosis (RO) and Nanofiltration (NF) membrane technology have been applied as these membranes remove both total dissolved solids (TDS) and hardness from water, although to different degrees depending on the operating conditions. In addition to removing hardness and TDS, micropollutants, bacteria, viruses, and other contaminants may also be removed. However, the current system designs are complex, require a large footprint, are difficult to install, are difficult to operate by users, and/or are expensive, which hinders their acceptance by homeowners or commercial end users.

Furthermore, membrane-based saltless whole home water treatment systems typically rely on either a pressurized bladder tank or an atmospheric tank to deliver the softened water to the point of use (POU). If a bladder tank is used, the tank pressure and the line pressure drop when water is dispersed, and the water supply may be interrupted. If an atmospheric tank is used, the water must be repressurized with a pump to meet the required line pressure for water delivery to the POU. The filling and emptying of an atmospheric tank also require air exchange, which offers a possibility for contaminants such as airborne bacteria to enter the system and may have a limited supply of filtered water depending on the size of the reservoir.

Therefore, to overcome the drawbacks of the current water treatment systems and methods, the present disclosure recognizes the need for an improved saltless whole home water treatment for residential and commercial uses.

### SUMMARY

The present systems, methods, and apparatuses overcome many of the shortcomings and limitations of the prior art devices and systems discussed above. The systems, methods, and apparatuses described include embodiments of a saltless water treatment system and associated methods. In one aspect, the present disclosure provides a water treatment system including a sediment filter for filtering untreated water in fluid communication with a source of the untreated water, wherein the untreated water enters the sediment filter and produces a first prefiltered water that exits the sediment filter, a carbon filter for filtering the first prefiltered water and in fluid communication with the sediment filter, wherein the first prefiltered water enters the carbon filter and produces a second prefiltered water that exits the carbon filter, an antiscalant feeder for adding an antiscalant to the second prefiltered water and in fluid communication with the carbon filter, wherein the second prefiltered water enters the antiscalant feeder and produces a third prefiltered water that exits the antiscalant feeder, a pump in fluid communication with the antiscalant feeder, a first membrane element for removing solutes from the third prefiltered water and in fluid communication with the pump, wherein the first membrane element produces a first permeate including the third prefiltered water imparted with a first concentration of solutes and a retentate including the third prefiltered water imparted with a second concentration of solutes, wherein the first concentration of solutes is less than the second concentration of solutes, the first membrane element in fluid communication with the pump, a second membrane element for removing solutes from the retentate and in fluid communication with the first membrane element via a retentate line, wherein the second membrane element produces a second permeate, a post-filtration subsystem including one or more mineralization cartridges in fluid communication with the first membrane element and the second membrane element via a permeate line, the post-filtration subsystem configured to add one or more minerals to the first permeate and the second permeate and produce mineralized water exiting the post-filtration subsystem, and a tank in fluid communication with the post-filtration subsystem and the carbon filter, wherein the tank stores second prefiltered water from the carbon filter in a bottom portion of the tank and the mineralized water from the post-filtration subsystem in a top portion of the tank, the tank configured to supply an outlet with the mineralized water before the second prefiltered water.

In another aspect, the present disclosure provides a water treatment system including a sediment filter for filtering untreated water in fluid communication with a source of the untreated water, wherein the untreated water enters the sediment filter and produces a first prefiltered water that exits the sediment filter, a carbon filter for filtering the first prefiltered water and in fluid communication with the sediment filter, wherein the first prefiltered water enters the carbon filter and produces a second prefiltered water that exits the carbon filter, an antiscalant feeder for adding an antiscalant to the second prefiltered water and in fluid communication with the carbon filter, wherein the second prefiltered water enters the antiscalant feeder and produces a third prefiltered water that exits the antiscalant feeder, a pump in fluid communication with the antiscalant feeder, one or more membrane elements for removing solutes from the third prefiltered water and generating a permeate stream, the one or more membrane elements in fluid communication with the pump, a post-filtration subsystem including one or more mineralization cartridges in fluid communication with the one or more membrane elements via a permeate line, the post-filtration subsystem configured to add one or more minerals to the permeate stream and produce mineralized water exiting the post-filtration subsystem, and a tank in fluid communication with the post-filtration subsystem and the carbon filter, wherein the tank stores second prefiltered water from the carbon filter in a bottom portion of the tank and the mineralized water from the post-filtration subsystem in a top portion of the tank, the tank configured to supply an outlet with the mineralized water before the second prefiltered water.

In yet another aspect, the present disclosure provides a water treatment system, including a sediment filter for filtering untreated water in fluid communication with a source of the untreated water, wherein the untreated water enters the sediment filter and produces a first prefiltered water that exits the sediment filter, a carbon filter for filtering the first prefiltered water and in fluid communication with the sediment filter, wherein the first prefiltered water enters the carbon filter and produces a second prefiltered water that exits the carbon filter, a pump in fluid communication with the carbon filter, one or more membrane elements for removing solutes from the second prefiltered water and generating a permeate water, the one or more membrane elements in fluid communication with the pump, and a tank in fluid communication with the post-filtration subsystem and the carbon filter, wherein the tank stores second prefiltered water from the carbon filter in a bottom portion of the tank and permeate water in a top portion of the tank, the tank configured to supply an outlet with the permeate water before the second prefiltered water.

These and other aspects and advantages of the present disclosure will become apparent to those skilled in the art after considering the following detailed description in connection with the accompanying drawings.

### BRIEF DESCRIPTION OF DRAWINGS

FIG. 1A is a schematic diagram of an embodiment of a saltless water treatment system;

FIG. 1B is a schematic diagram of an embodiment of another saltless water treatment system;

FIG. 2 is a perspective view of an enclosure system configured to house components of the water treatment system in FIG. 1A;

FIG. 3 is a rear view of the enclosure system of FIG. 2;

FIG. 4A is a perspective view of a processor enclosure in FIG. 2 with doors opened;

FIG. 4B is a front view of the processor enclosure in FIG. 2 with doors opened.

FIG. 5 is a schematic block diagram of an embodiment of a control system for a saltless water treatment system;

FIG. 6 is a schematic diagram of an embodiment of an operational cycle of the saltless water treatment systems of FIG. 1A;

FIG. 7 is a flow diagram of a method for controlling a status light;

FIG. 8 is a flow diagram of a method for installing the water treatment systems of FIG. 1A and FIG. 1B;

FIG. 9 is a flow diagram of a method for determining leaks;

FIG. 10 is a flow diagram of another method for determining leaks;

FIG. 11 is a flow diagram of yet another method for determining leaks;

FIG. 12 is a flow diagram of a further method for determining leaks;

FIG. 13 is a flow diagram of a method for performing an active flush cycle; and

FIG. 14 is a flow diagram of a method for performing a freeze protection cycle.

### DETAILED DESCRIPTION

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

Additionally, while the following discussion may describe features associated with specific devices or embodiments, it is understood that additional devices and/or features can be used with the described systems and methods, and that the discussed devices and features are used to provide examples of possible embodiments, without being limited.

At a high level, embodiments of the water treatment systems disclosed herein may include multiple system components that may be located at various locations or points within the water treatment systems. Although other fluids may be processed by the water treatment systems disclosed herein, for purposes of discussion and illustration, the present disclosure will refer to all possible fluids simply as water.

Some embodiments of the water treatment systems disclosed herein may include one or more pipes, conduits, tubing, or other feed or fluid transfer lines, which may connect system components and form a fluid circuit and/or fluid flow path, and allow water to flow from an inlet, through the water treatment system, to an outlet.

Some embodiments of the water treatment systems may include one or more valves to control and regulate water flow into, through, and out of the water treatment system. For example, in some embodiments, the valves may be provided in the form of a gate valve, check valve, or an actuated ball valve. Some embodiments of the water treatment systems may include one or more prefiltration units to remove sediment, certain chemicals, organics, and other undissolved impurities from inlet water. For example, in some embodiments, the prefiltration units may include a sediment filter or carbon filter. Some embodiments of the water treatment systems may include one or more sensors to measure, monitor, or sense variations in the water at different points in the system including dissolved sediment levels, water conductivity, water flow rates, water temperature, water pressure, water clarity, water volume, ion concentration, or water alkalinity. For example, in some embodiments, the sensors may be provided in the form of a total dissolved solids (TDS) sensor or probe, a flowmeter, a temperature sensor, a pressure sensor or transducer, an oxidation reduction potential (ORP) probe, a colorimeter sensor, an ion-selective electrode sensor, a volume-based batching sensor, and/or a pH sensor.

Some embodiments of the water treatment systems may include one or more membrane elements to remove hardness minerals, micropollutants, bacteria, viruses, and other contaminants from the water. In some embodiments, the membrane elements may be provided in the form of a RO membrane or a NF membrane. Some embodiments of the water treatment systems may include one or more feeders for introducing chemical additives to the water. Some embodiments of the water treatment systems may include one or more pumps to control or regulate water pressure in the system. Some embodiments of the water treatment systems may include one or more storage or retention tanks for holding or storing water that may have been filtered by a prefiltration unit or treated by a membrane element. Some embodiments of the water treatment systems may include one or more valves or capillary flow restrictors to regulate the flow of retentate exiting the system. Furthermore, some embodiments of the water treatment systems may include one or more control systems that may include a controller for monitoring, controlling, and communicating with one or more system components including, the valves, sensors, feeders, or pumps. The control system may also include one or more display panels or screens for providing information about the water treatment system to a user.

Embodiments of the water treatment systems disclosed herein may be self-mediating in that the flow of water through the water treatment systems may be controlled or regulated by the physical equilibrium of hydrodynamic forces such that actuated valves, pumps, or flow controllers may not be needed depending on flow conditions. More specifically, water pressure in the various lines of the water treatment system may be retained such that as water flows out of one area of the water treatment system, the pressure in such area may decrease. Water in other areas may then flow toward the area with lower pressure until an equilibrium of pressure within the system is reached. In some embodiments, a pressurized retention tank may be filled with water and the flow of water into and out of a retention tank may be automatic such that actuated valves or flow controllers may not be required or may be omitted for certain operations.

Embodiments of the water treatment systems disclosed herein may include processes for extending the lifetime of the membrane element. Such processes may include using a permeate flush and soak, and/or a forward membrane flush at a high flow rate, and the other membrane cleaning processes described herein. The process of ions forming scale on the membrane surface is not instantaneous. If the concentrated solution is rinsed off the membrane quickly, ions in the solution may not have time to precipitate and form scale. Various systems and methods are provided in which the membrane is flushed with water imparted with a low mineral concentration or water dosed with a chemical additive to help prevent scale formation. In addition, high velocity may be used to further encourage displacement of unwanted foulants.

Embodiments of the water treatment systems disclosed herein may include physical and/or chemical cleaning processes in the form of mechanical, and/or time-based cleaning techniques. For example, the physical cleaning processes may include membrane flush, rinse, and/or soak processes, said processes utilizing inlet water or permeate water. Chemical processes may include a membrane flush, rinse, soak, or clean-in-place processes, the processes utilizing a chemical additive.

Embodiments of the water treatment systems disclosed herein may include adding a chemical additive (e.g., a chelation agent, a polyphosphate compound, and/or an acidic compound) before the water is provided to the membrane element as a rinse or soak.

Embodiments of a water treatment system disclosed herein provide several advantages over current water treatment systems. One advantage of the water treatment systems disclosed is that they provide for a simplified saltless water treatment system. For example, the water treatment systems may operate with only a single pump and tank. Another advantage of the unique design of the water treatment systems disclosed is that the water treatment systems enable a continuous supply of water to a point of use in a residential or commercial property. For example, the tank may be in fluid communication with inlet water via a prefiltration unit such that prefiltered water may flow through the tank directly to an outlet, rather than having to first go through a membrane element. Providing the storage tank in parallel with the membrane element enables the water treatment system to always provide water to a point of use within a residential or commercial property even during high-demand periods. Further, the water treatment systems disclosed herein use physical equilibrium of hydrodynamic forces to help ensure that water may always be supplied to a point of use, even if there is a power outage, unless the water source is a well. Furthermore, the water treatment system utilizes a prefiltration unit such that the residential or commercial property will always have at least some level of filtered water flowing to a point of use, even if the inlet water is not provided to the membrane element before being provided to the point of use. The prefiltration unit may provide a continuous stream of prefiltered water to the point of use, even if there is a power outage, if there is sufficient water pressure at the inlet 102.

Another advantage of the embodiments of a water treatment system disclosed herein is that the unique design of the water treatment system enables the membrane element to operate at least about an 80% recovery rate, at least about an 85% recovery rate, or at least about a 90% recovery rate or greater, which may prolong and/or aid in the prolonging of the life of the membrane. To enable such a high recovery rate, the water treatment systems disclosed may use, for example, a prefiltration unit to remove larger particulates (e.g., particulates with a diameter of greater than about 5 microns) from the inlet water to minimize the clogging of pores in the membrane element. In addition, in some embodiments of the water treatment system disclosed herein, a permeate flush, e.g., low TDS water, may be used to clean the membrane element. Low TDS water may be any water imparted with a TDS concentration lower than the TDS concentration of the inlet water provided to the system. Additionally, or alternatively, low TDS water may be water imparted with a TDS concentration of less than about 3.5 grains per gallon (60 milligrams per liter). Using a permeate flush to clean the membrane as part of the operational cycle of the water treatment system minimizes the build-up of scale on the membrane element because the surface of the membrane element may not be habitually exposed to water with a high TDS content. High TDS water may be water imparted with a TDS concentration that is about equal to or greater than the TDS concentration of the inlet water entering the system. Additionally, or alternatively, high TDS may be water imparted with a TDS concentration greater than about 3.5 grains per gallon (60 milligrams per liter). Furthermore, in some embodiments of the water treatment systems disclosed herein, a chemical additive released by a feeder may be used to maintain membrane element health.

A further advantage of the embodiments of a water treatment system disclosed herein is the use of one or more sensors that may be in communication with a control system that may be Internet of Things compatible. Thus, the water treatment system may allow for remote monitoring, control, and troubleshooting, and enable connection and communication with other user devices (e.g., a mobile phone). In some embodiments, the water treatment system may use one or more sensors to detect potential operational or component issues and self-diagnose. For example, the measurements provided by the one or more sensors may be used by the control system in combination with another sensor of the same type (e.g., one or more TDS sensors) or a sensor of a different type (e.g., a flowmeter in combination with a pressure sensor) to monitor the health of a membrane element, to trigger the pump on or off, and/or to detect a condition (e.g., an increase in the amount of high TDS water in the tank). As another example, measurements provided by one or more pressure sensor may be used by the control system to monitor filter health and/or membrane health.

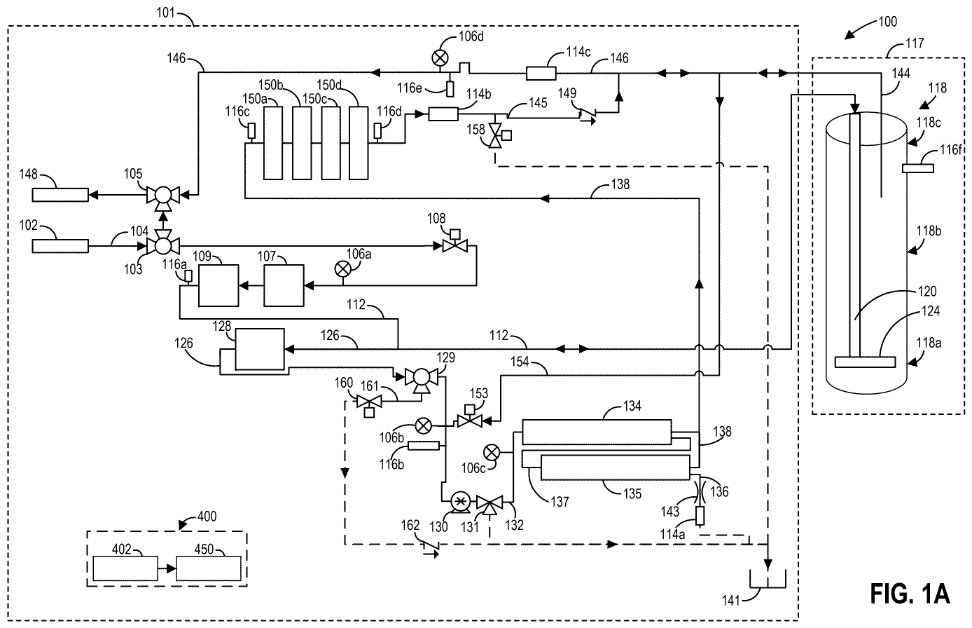

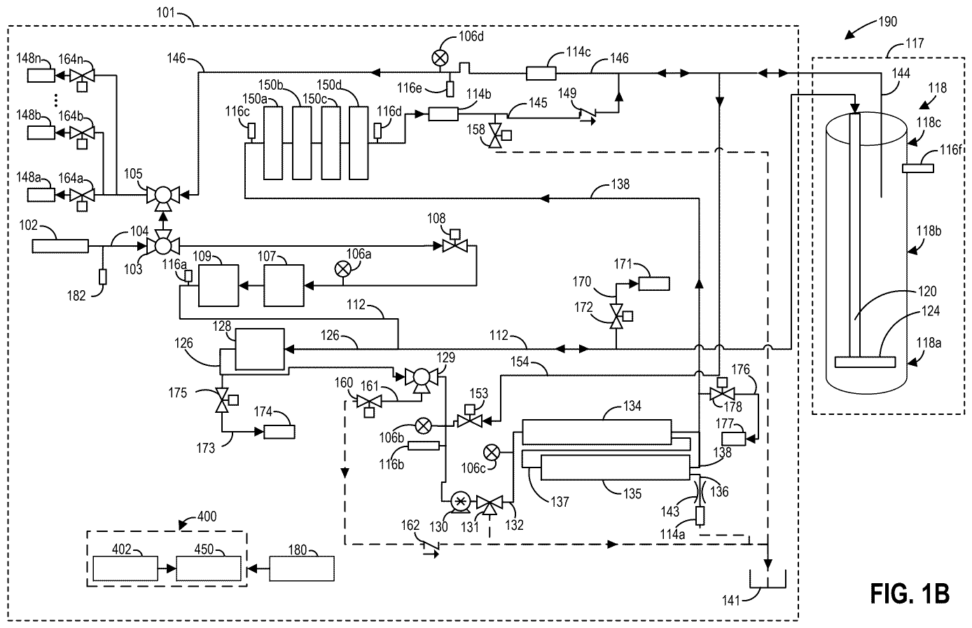

FIG. 1A illustrates an embodiment of a water treatment system 100. The water treatment system 100 may include a processor subsystem 101 and a tank subsystem 117. The processor subsystem 101 may be coupled to the tank subsystem 117 via a tank line 144 and a prefiltered water line 112.

The processor subsystem 101 may include an inlet 102 through which inlet water (e.g., hard water) enters the water treatment system 100. The processor subsystem 101 may include an outlet 148 in which postprocessed permeate (e.g., remineralized permeate) and/or prefiltered water is supplied to a point of use.

The inlet water may pass through a prefiltration subsystem including a sediment filter 107 and a carbon filter 109, where the inlet water may be filtered, and sediment or other contaminants may be removed. Water that has passed through the sediment filter 107 and the carbon filter 109 may be referred to as prefiltered water. The prefiltered water may flow into a tank 118 included in the tank subsystem 117 where the prefiltered water is stored for future processing by a membrane subsystem including a first membrane element 134 and a second membrane element 135 of the processor subsystem 101. The prefiltered water may also flow into and through the tank 118 to the outlet 148 of the water treatment system 100 for immediate use. Alternatively, or additionally, the prefiltered water may flow toward the first membrane element 134 and the second membrane element 135 after passing through the sediment filter 107 and the carbon filter 109. As the prefiltered water flows toward the membrane elements 134-135, the prefiltered water may pass a feeder subsystem including an antiscalant feeder 128, which is designed to add a polyphosphate to the prefiltered water. After passing the antiscalant feeder 128, the prefiltered water may flow through the membrane elements 134-135. The membrane elements 134-135 may further filter the prefiltered water to remove hardness minerals and other impurities. A pump 130 located on a feed side of the first membrane element 134 may be used to direct the prefiltered water toward the first membrane element 134. The first membrane element 134 may generate permeate and retentate. The permeate from the first membrane element 134 may flow to a post-filtration subsystem 150 included in the processor subsystem 101. The retentate from the first membrane element 134 may flow to the second membrane element 135. The second membrane element 135 may generate permeate and retentate. The permeate from the second membrane element 135 may flow to the post-filtration subsystem 150. The retentate from the second membrane element 135 may flow to a drain 141. The permeate produced by the first membrane element 134 and the permeate produced by the second membrane element 135 may collectively be referred to as membrane filtered water.

The membrane filtered water can flow to the post-filtration subsystem 150. The post-filtration subsystem 150 can include one or more mineralization elements. As shown, the post-filtration subsystem 150 includes a first mineralization cartridge 150a, a second mineralization cartridge 150b, a third mineralization cartridge 150c, and a fourth mineralization cartridge 150d. The mineralization cartridges 150a-d can add one or more minerals into the membrane filtered water. Water passed through the mineralization cartridges 150a-d may be referred to as mineralized water and/or remineralized water. The mineralized water may flow to the tank 118 for storage or may flow directly out of the outlet 148 of the processor subsystem 101 to a point of use.

The water treatment system 100 may have one or more sensors (e.g., 106a-106d, 114a-114c, 116a-116f) that may be disposed at various points in the water treatment system 100 to measure or monitor a characteristic of the water (e.g., pressure, flow rate, conductivity, total dissolved solids, etc.) and provide data to a controller 402. Furthermore, one or more valves (e.g., 108, 129, 153, 158, 160, 131) may be included at various points of the water treatment system 100 to control the flow of water into, through, and out of the water treatment system 100.

Still referring to FIG. 1A, the inlet 102 of the water treatment system 100 may be in fluid communication with an inlet line 104. The inlet water may be provided from an inlet water source (not shown). The inlet water source may be, for example, a municipal water source, a well, or other influent water source. The inlet water may be imparted with a hardness value of about 1 grain per gallon (17.1 milligrams per liter) to about or above 10 grains per gallon (over 180 milligrams per liter). In some embodiments, the inlet water may be imparted with a hardness value of about 30 grains per gallon (about 514 milligrams per liter).

The processor subsystem 101 may include an inlet bypass valve 103 and an outlet bypass valve 105. Each of the inlet bypass valve 103 and the outlet bypass valve 105 may be a three-way hand valve. A user (e.g., an installer) may actuate the bypass valves 103, 105 and cause the inlet line 104 to be fluidly coupled to the outlet line 146 and place the processor subsystem 101 in a bypass configuration. The processor subsystem 101 may allow inlet water from the inlet 102 to flow toward the outlet 148 and bypass other components of the processor subsystem 101 in the bypass configuration. A user may place the processor subsystem 101 in the bypass configuration during installation and/or servicing of the water treatment system 100. The bypass valves 103, 105 may place the processor subsystem 101 in a normal configuration when the inlet bypass valve 103 allows flow from the inlet 102 to a first actuated valve 108 and when the outlet bypass valve 105 allows flow from the outlet line 146 to the outlet 148.

The water treatment system 100 may include one or more pressure sensors 106. In some embodiments, the one or more pressure sensors 106 may be defined by a gauge pressure transmitter, a differential pressure transmitter, an absolute pressure transmitter, a multivariate pressure transmitter, or a submersible pressure transmitter.

A first pressure sensor 106a may be in fluid communication with the inlet line 104. The first pressure sensor 106a may measure, monitor, or sense the pressure of the inlet water in the inlet line 104.

The water treatment system 100 may include the first actuated valve 108. The first actuated valve 108 may be in fluid communication with the inlet line 104. As shown, the first actuated valve 108 is positioned upstream of the pressure sensor 106a. In some embodiments, the first actuated valve 108 may be positioned downstream of the pressure sensor 106a. In some embodiments, the first actuated valve 108 may be a gate valve. In some embodiments, the first actuated valve 108 may be a butterfly valve, a ball valve, or a globe valve. The first actuated valve 108 may be an electric valve.

The first actuated valve 108 may control or regulate the amount of inlet water entering the water treatment system 100 when the inlet bypass valve 103 is open. The first actuated valve 108 may open, either partially or fully, to enable the flow or increase the amount of inlet water entering the water treatment system 100 through the inlet 102. The first actuated valve 108 may close, either partially or fully, to stop or decrease the flow or amount of inlet water entering the water treatment system 100. The amount of inlet water entering the water treatment system 100 may increase or decrease the water pressure in the water treatment system 100.

The water treatment system 100 may include the prefiltration subsystem including the sediment filter 107 and the carbon filter 109. The prefiltration subsystem may be in fluid communication with the inlet line 104 and a prefiltered water line 112. More specifically, inlet water may enter the sediment filter 107 via the inlet line 104 and exit the carbon filter 109 via the prefiltered water line 112. When inlet water passes through the sediment filter 107, the sediment filter 107 may remove sediment and/or particulates, from the inlet water. Water may exit from the sediment filter 107 and enter the carbon filter 109. When water from the sediment filter enters the carbon filter 109, the carbon filter 109 may remove certain chemicals or other contaminants from the water, producing a prefiltered water that may flow out of the prefiltration subsystem (e.g., at an outlet of the carbon filter 109) via the prefiltered water line 112.

The sediment filter 107 may remove sediments, such as sand, silt, and dirt, and other particulates such as rust from the inlet water. In some embodiments, the sediment filter 107 may include a filter media including pores with a pore size of no more than 5 microns, or no more than about 5 microns. For example, the sediment filter 107 may include a filter media including pores with a pore size of no more than 5 microns, no more than 4 microns, no more than 3 microns, no more than 2 microns, no more than 1 micron, no more than 0.5 microns, or no more than 0.1 microns. As an additional example, the sediment filter 107 may include a filter media including pores with a pore size of no more than about 5 microns, no more than about 4 microns, no more than about 3 microns, no more than about 2 microns, no more than about 1 micron, no more than about 0.5 microns, or no more than about 0.1 microns. In other embodiments, the sediment filter 107 may include a depth media, woven fabric, or nonwoven fabric.

In some embodiments, the carbon filter 109 may be an activated carbon filter. The activated carbon filter may remove certain chemicals such as chlorine, chloramine, and hydrogen sulfide or contaminants such as lead from the inlet water. The activated carbon filter may include a carbon-rich filter media that traps or absorbs the chlorine, chloramine, hydrogen sulfide, or lead in the filter media. In some embodiments, the activated carbon media may be provided in the form of a radial flow element, granular activated carbon, an activated carbon block, activated carbon suspended in a fibrous matrix, and the like.

By removing sediment, chlorine, chloramine, and other contaminants, the prefiltration subsystem may provide prefiltered water that may have substantially no odor and have an improved taste compared to the inlet water. In addition, by removing sediment, chlorine, chloramine, and other contaminants the prefiltration subsystem may protect the downstream membrane elements 134-135 from sediment fouling or oxidation.

In some embodiments, the carbon filter 109 may be a PENTAIR® PENTEK® BIG BLUE® filter including a RFC20-BB filter media. In some embodiments, the sediment filter 107 may be a PENTAIR® PENTEK® BIG BLUE® filter including a DGD-2501 filter media.

The water treatment system 100 may include one or more TDS sensors 116. In some embodiments, the TDS sensors may have an input voltage of at least about 3.3-5.5 volts (V), at least about a 0-2.3V analog voltage output, with a working current of at least about 3-6 milliampere, a TDS measurement range of at least about 0-1000 parts per million (ppm), and TDS measurement accuracy of at least about ±10% Full Scale (25° C.). In some embodiments, the one or more TDS sensors 116 may be a TDS sensor having a TDS measurement range of at least about 0 to about 3000 ppm or greater than about 3000 ppm. In other embodiments, the TDS sensor may be a flexible TDS probe as described in U.S. patent application Ser. No. 17/657,916 owned by Pentair Residential Filtration, LLC and incorporated herein by reference. Each of the one or more TDS sensors 116a-116h may be the same type of TDS sensor or may each be a different type of TDS sensor.

A first TDS sensor 116a may be in fluid communication with the prefiltered water line 112. The first TDS sensor 116a may measure, monitor, or sense the conductivity of the prefiltered water to determine a concentration or an amount of dissolved solids in the prefiltered water (e.g., inlet water that has passed through the prefiltration subsystem).

The water treatment system 100 may include a second pressure sensor 106b that may be in fluid communication with the prefiltered water line 112. The second pressure sensor 106b may measure, monitor, or sense the pressure of the prefiltered water in the prefiltered water line 112.

The water treatment system 100 may include the tank 118, which may be used to store water. The tank 118 may be defined by a housing having a bottom portion 118a, a center portion 118b, and a top portion 118c. The tank 118 may be a flow through tank, which may allow for the seamless delivery of water to a point of use (POU). In some embodiments, the tank 118 may be a fiberglass reinforced plastic (FRP) tank. The tank 118 may have a capacity of about 50 gallons (189 liters). In some embodiments, the tank 118 may range in size from about 24 gallons (91 liters) to about 200 gallons (757 liters). In some embodiments, existing water vessels within the residential or commercial property (e.g., a water heater) may be used for additional storage capacity.

The tank 118 may include a riser tube 120 that extends upwardly vertically from the bottom portion 118a of the tank 118 to the top portion 118c of the tank 118, or vice versa. The riser tube 120 may be in fluid communication with the prefiltered water line 112. In some embodiments, the riser tube 120 may be provided as PVC tubing.

The tank 118 may further include a flow distributor 124, which may be attached or coupled to the riser tube 120. The flow distributor 124 may prevent or reduce the mixing of higher TDS water that may be stored in the bottom portion 118a of the tank 118 with lower TDS water that may be stored in the top portion 118c of the tank 118. In some embodiments, the flow distributor 124 may be a dome flow distributor. In some embodiments, multiple flow distributors 124 may be used.

Additionally, the tank 118 may include baffles and external plumbing (e.g., flow distributors) to reduce the mixing of higher TDS water that may be stored in the bottom portion 118a of the tank 118 with lower TDS water that may be stored in the top portion 118c of the tank 118.

In some embodiments, the high TDS water is added to the bottom portion 118a of the tank 118 and the low TDS water is added to the top portion 118c of the tank 118. Advantageously, adding the high TDS water and the low TDS water to the tank 118 in this manner helps maintain the separation between the high TDS water and the low TDS water in the tank 118, which in turn helps ensure that low TDS water is provided to a point of use during operation of the tank 118.

The water treatment system 100 may include an additive line 126. The additive line 126 may be physically connected to or otherwise in fluid communication with the prefiltered water line 112.

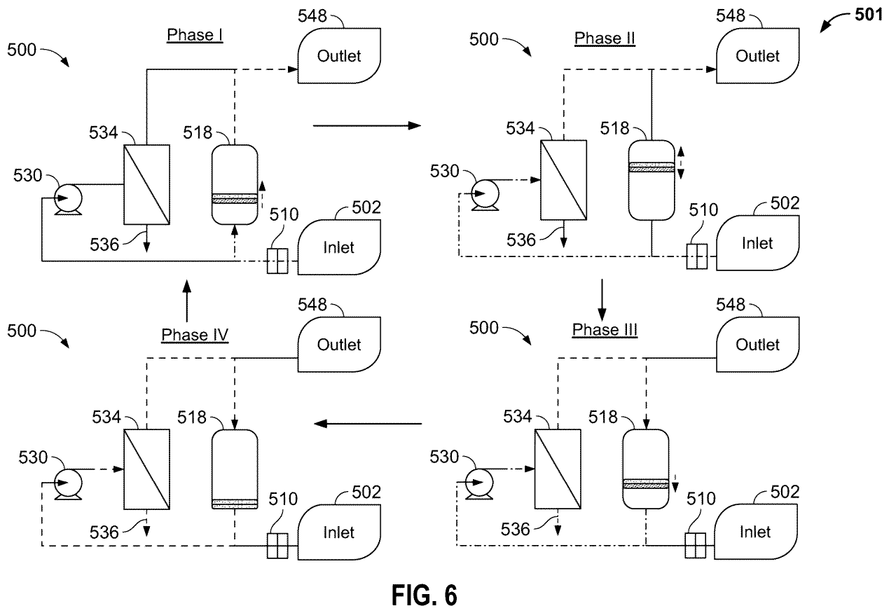

The prefiltered water may have a fluid flow path through the water treatment system 100. In some embodiments, depending on the flow conditions when the water treatment system 100 is in use, the prefiltered water may flow in different directions as described in more detail below (see, e.g., FIG. 6. For example, during some flow conditions, the prefiltered water may flow directly from the carbon filter 109 through the prefiltered water line 112, down the riser tube 120, and into the bottom portion 118a of the tank 118. The prefiltered water may be stored in the tank 118. During other flow conditions, the prefiltered water may flow from the carbon filter 109 via the prefiltered water line 112 toward the first membrane element 134 via the additive line 126 and a membrane feed line 132. During further flow conditions, the prefiltered water may flow from the bottom portion 118a of the tank 118, up the riser tube 120, through the prefiltered water line 112 toward the membrane element 134 via the additive line 126 and the membrane feed line 132.

The water treatment system 100 may include the antiscalant feeder 128 that is in fluid communication with the additive line 126. The antiscalant feeder 128 may introduce or add an anti-scaling agent to reduce corrosion or scale on a feed side of a membrane element. In some embodiments, the anti-scaling agent may be a polyphosphate.

In some embodiments, when the prefiltered water flows through or passes by the antiscalant feeder 128, the anti-scaling agent may be added or introduced to the prefiltered water. The anti-scaling agent may dissolve or otherwise degrade in the prefiltered water. In some embodiments, as further detailed herein, the antiscalant feeder 128 may impart the water flowing through the antiscalant feeder 128 with an anti-scaling agent concentration of at least about 0.01 ppm to at least about 10 ppm, or at least 0.01 ppm to at least 10 ppm. In other embodiments, the antiscalant feeder 128 may impart the water flowing through the antiscalant feeder 128 with an anti-scaling agent concentration of less than 0.01 ppm or greater than 10 ppm of the chemical additive.

The water treatment system 100 may include a second pressure sensor 106b that may be in fluid communication with the additive line 126. The second pressure sensor 106b may measure, monitor, or sense the pressure of the prefiltered water with additive in the additive line 126.

The water treatment system 100 may include a second actuated valve 129. The second actuated valve 129 may be in fluid communication with the additive line 126 and a prefilter flush line 161. In some embodiments, the second actuated valve 129 may be a ball valve. The second actuated valve 129 may be an electric valve. The second actuated valve 129 may control or regulate the amount of prefiltered water in the additive line 126 provided to the pump 130. The second actuated valve 129 may open, either partially or fully, to enable the flow or increase the amount of prefiltered water provided to the pump 130. The second actuated valve 129 may close, either partially or fully, to stop or decrease the amount of prefiltered water provided to the pump 130. The second actuated valve 129 may also control or regulate the amount of prefiltered water in the additive line 126 provided to a fifth actuated valve 160 in fluid communication with the prefilter flush line 161. The second actuated valve 129 may open, either partially or fully, to enable the flow or increase the amount of prefiltered water provided to the fifth actuated valve 160. The second actuated valve 129 may close, either partially or fully, to stop or decrease the amount of prefiltered water provided to the fifth actuated valve 160.

The water treatment system 100 may include a second pressure sensor 106b in fluid communication with the additive line 126. The second pressure sensor 106b may measure, monitor, or sense the pressure of the prefiltered water in the additive line 126.

The water treatment system 100 may include a second TDS sensor 116b. The second TDS sensor 116b may be in fluid communication with the additive line 126. The second TDS sensor 116b may measure, monitor, or sense the conductivity of the prefiltered water to determine an amount or concentration of dissolved solids in the prefiltered water. The prefiltered water with additive may have a higher TDS than the prefiltered water without additive.

The water treatment system 100 may include the pump 130. An inlet side (not shown) of the pump 130 may be in fluid communication with the additive line 126, and an outlet side (not shown) of the pump 130 may be in fluid communication with the membrane feed line 132. In some embodiments, the pump 130 may be a single-phase booster pump. For example, the pump 130 may be a single-phase 220 volt, 2 horsepower pump. In some embodiments, the pump 130 may be a Grundfos CM 3-8 220V 3 HP pump. In some embodiments, the pump 130 may be a multi-phase booster pump. In some embodiments, the pump 130 may boost differential pressure in the membrane feed line 132 to 120-250 pounds per square inch (827-1725 kilopascals) at a flow rate of 1.0-7.0 gallons per minute (11-26 liters per minute) or at a preferable flow rate of 2.0-6.0 gallons per minute (7.5-23 liters per minute).

The membrane feed line 132 may be in fluid communication with a third pressure sensor 106c. The third pressure sensor 106c may measure, monitor, or sense the pressure of the prefiltered water in the membrane feed line 132.

The water treatment system 100 may include a pressure relief valve 131 in fluid communication with the membrane feed line 132 and the drain 141. The pressure relief valve 131 may relieve excess pressure that may build up in the membrane feed line 132.

The water treatment system 100 may include the first membrane element 134 and the second membrane element 135. In some embodiments, first membrane element 134 and the second membrane element 135 are reverse osmosis (RO) membranes. In some embodiments, the RO membranes may be spiral wound and may include feed spacers imparted with a certain thickness and/or structure. In some embodiments, the RO membranes may be a spiral wound RO membrane (e.g., a spiral wound 4040 RO membrane) including feed spacers imparted with a thickness of no more than about 8 mil to no more than about 40 mil, although in some instances the thickness of the feed spacers may be less than about 8 mil or even greater than about 40 mil. For example, the RO membranes may have feed spacers imparted with a thickness of no more than about 8 mil, or no more than about 9 mil, or no more than about 11 mil, or no more than about 13 mil, or no more than about 15 mil, or no more than about 18 mil, or no more than about 21 mil, or no more than about 24 mil, or no more than about 27 mil, or no more than about 30 mil, or no more than about 35 mil, or no more than about 40 mil. In other instances, the RO membranes may be a spiral wound RO membranes (e.g., a spiral wound 4040 RO membrane) with feed spacers imparted with a thickness of at least 8 mil to no more than 40 mil. For example, the feed spacers may be imparted with a thickness of no more than 8 mil, or no more than 9 mil, or no more than 11 mil, or no more than 13 mil, or no more than 15 mil, or no more than 18 mil, or no more than 21 mil, or no more than 24 mil, or no more than 27 mil, or no more than 30 mil, or no more than 35 mil, or no more than 40 mil. In addition, in some embodiments, the feed spacers may have a diamond-shaped structure. In other embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

In some embodiments, the RO membranes may be spiral wound RO membranes (e.g., spiral wound 4040 RO membranes) including feed spacers imparted with a thickness of no more than about 0.2 millimeters to no more than about 1.1 millimeters, although in some instances the thickness of the feed spacers may be less than about 0.2 millimeters or even greater than about 1.1 millimeters. For example, the RO membranes may have feed spacers imparted with a thickness of no more than about 0.2 millimeters, or no more than about 0.25 millimeters, or no more than about 0.3 millimeters, or no more than about 0.35 millimeters, or no more than about 0.4 millimeters, or no more than about 0.5 millimeters, or no more than about 0.6 millimeters, or no more than about 0.7 millimeters, or no more than about 0.8 millimeters, or no more than about 0.9 millimeters, or no more than about 1.1 millimeters. In other instances, the RO membranes may be spiral wound RO membranes (e.g., a spiral wound 4040 RO membranes) with feed spacers imparted with a thickness of at least 0.2 millimeters to no more than 1.1 millimeters. For example, the RO membranes may have feed spacers imparted with a thickness of no more than 0.2 millimeters, or no more than 0.25 millimeters, or no more than 0.3 millimeters, or no more than 0.35 millimeters, or no more than 0.4 millimeters, or no more than 0.5 millimeters, or no more than 0.6 millimeters, or no more than 0.7 millimeters, or no more than 0.8 millimeters, or no more than 0.9 millimeters, or no more than 1.1 millimeters. In addition, in some embodiments, the feed spacers may have a diamond-shaped structure. In other embodiments, the feed spacers may be manufactured into alternative geometries aside from the diamond-shaped structure using 3D printing technology. In other embodiments, the feed spacers may be printed directly onto the membrane surface. In further embodiments, multiple feed spacer designs may be used within a single membrane element.

Arranging the first membrane element 134 and the second membrane element 135 in series may help maintain a higher velocity on the feed side of the individual membranes, which in turn may reduce ion concentration at the membrane surface of each membrane. In addition, including two RO membranes in series may enable the operation of the individual RO membranes at different membrane recoveries, which may help optimize permeate production as dissolved mineral content increases. Furthermore, arranging identical RO membranes in series can allow the first membrane element 134 to be rotated into the position of and replace the second membrane element 135 when the first membrane element 134 is replaced, furthering the lifespan of the first membrane element 134 and potentially reducing the overall replacement rate of the RO membranes used as the membrane elements 134-135.

In some embodiments, the membrane elements 134-135 of the water treatment system 100 may be provided in the form of a nanofiltration (NF) membrane element or a NF membrane module comprising a NF membrane. In some such embodiments, the NF membrane may enhance permeate production of the membrane elements 134-135 while also producing a “balanced” permeate water imparted with a desired taste profile. The balanced permeate water may also mitigate the potential for scale formation downstream of the membrane elements 134-135. In some embodiments, the NF membrane element may be spiral wound and may include feed spacers imparted with a certain thickness and/or structure. In some embodiments, the NF membrane element may have a specified diameter, for example, a 4-inch diameter, allowing for a desired amount and/or a desired surface area of NF membrane to be incorporated into the NF membrane element. In some cases, the NF membrane may be designed to provide one or more desired performance and/or separation characteristics, including, for example, total hardness rejection percentages, calcium rejection percentages, TDS rejection percentages, alkalinity rejection percentages, pollutant rejection percentages, permeate pH values, membrane permeance values, and permeate flow rates.

Various examples of the one or more desired performance and/or separation characteristics are provided. In some embodiments, the NF membrane may be designed to maximize membrane permeance. In some embodiments, the NF membrane may be designed such that the NF membrane element maximizes a production level of permeate flow. In some embodiments, the NF membrane may be designed to have a targeted range of total hardness rejection to impart a desired taste profile and/or a desired water chemistry, while also reducing or eliminating impacts associated with water hardness (e.g., scaling). In some embodiments, a total hardness of a permeate can be measured against standard indices, including, for example, a Langelier Saturation Index (LSI), a Calcite Precipitation Potential (CPP), a Larson-Skold Index, a Riddick Index, and a Feigenbaum Index. In some embodiments, the NF membrane may be designed to have a targeted range of calcium hardness rejection to reduce scaling potential while avoiding corrosion. In some embodiments, the NF membrane may be designed to have a targeted range of alkalinity rejection to reduce scaling potential while avoiding corrosion. In some embodiments, the NF membrane may be designed to have a targeted range of TDS rejection to impart a desired taste profile and/or desired water chemistry parameters. In some embodiments, the NF membrane may be designed to produce permeate having a targeted pH range to achieve a desired taste profile and/or desired water chemistry parameters while meeting drinking water standards.

In some embodiments, the NF membrane may provide desired separation characteristics while further removing pollutants, for example, micro-pollutants and/or heavy metals, from a feed stream. For example, the NF membrane may be designed to allow a predetermined amount of calcium and other dissolved solids to pass through the NF membrane while also preventing permeation of various micro-pollutants (e.g., large organic molecules, such as per- and polyfluoroalkyl substances (PFAS), commonly referred to as “forever chemicals”) and heavy metals.

In some cases, the NF membrane may have been treated or otherwise processed to provide one or more desired separation characteristics including, for example, calcium rejection percentages, TDS rejection percentages, alkalinity rejection percentages, permeate pH values, flux values, and permeate flow rates. For example, the NF membrane may have undergone treatment with one or more corrosive agents to tailor pore geometry and impart desired performance characteristics to the NF membrane. Thus, the NF membrane may be treated, processed, or designed to produce a permeate water with predetermined, defined, or desired characteristics.

In some embodiments, the NF membrane may provide desired separation characteristics that eliminate the need for post-filtration remineralization prior to consumption and/or use. This can be verified by the levels of various parameters in the permeate water such as, but not limited to, TDS, hardness, alkalinity, pH, LSI, and CPP. In such instances, a mineralization unit may be omitted from the water treatment system 100.

In some embodiments, the NF membrane may be treated, processed, or designed to provide a desired calcium rejection percentage. In some embodiments, the NF membrane may have a desired calcium rejection percentage of at least about 60% to no more than about 95%, although the desired calcium rejection percentage may be somewhat less or somewhat greater than these values. For example, the NF membrane may have a desired calcium rejection percentage of at least about 75% to no more than about 90%, or at least about 80% to no more than about 85%, or at least about 81% to no more than about 84%.

In some embodiments, the NF membrane may be treated, processed, or designed to provide a desired calcium rejection percentage that meets or exceeds a targeted rejection percentage. In some embodiments, the NF membrane may have a desired calcium rejection percentage of at least about 60%, or at least about 65%, or at least about 70%, or at least about 73%, or at least about 75%, or at least about 76%, or at least about 77%, or at least about 78%, or at least about 79%, or at least about 80%, or at least about 81%, or at least about 82%, or at least about 83%, or at least about 84%, or at least about 85%, or at least about 86%, or at least about 87%, or at least about 88%, or at least about 89%, or at least about 90%.

It is to be understood that, for different chemistries of the inlet water provided to the water treatment system 100, the NF membrane may reduce the calcium concentration of the inlet water by varying levels. For example, if the inlet water is moderately hard, about a 75% reduction in calcium concentration may be indicative of good or excellent membrane performance. As an additional example, if the inlet water is very hard, about a 90% reduction may be more appropriate.

In some embodiments, the NF membrane may be treated, processed, or designed to provide a desired calcium rejection percentage that does not exceed a targeted rejection percentage. In some embodiments, the NF membrane may have a desired calcium rejection percentage that is no more than about 90%, or no more than about 89%, or no more than about 88%, or no more than about 87%, or no more than about 86%, or no more than about 85%, or no more than about 84%, or no more than about 83%, or no more than about 82%, or no more than about 81%, or no more than about 80%, or no more than about 79%, or no more than about 78%, or no more than about 77%, or no more than about 76%, or no more than about 75%, or no more than about 70%.

It is to be appreciated that the desired calcium rejection percentage may be imparted with a discrete value, or range of values, falling within any minimum and maximum values or ranges recited herein with reference to the desired calcium rejection percentage.

In some embodiments, the NF membrane may be treated, processed, or designed to have a desired TDS rejection percentage. In some embodiments, the NF membrane may be imparted with a desired TDS rejection percentage of at least about 70% to no more than about 90%, although the desired TDS rejection percentage may be somewhat less or greater than these values. For example, the NF membrane may be treated, processed, or designed to have a desired TDS rejection percentage of at least about 75% to no more than about 90%, or at least about 80% to no more than about 85%, or at least about 81% to no more than about 84%.

In some embodiments, the NF membrane may be treated, processed, or designed to provide a desired TDS rejection percentage that meets or exceeds a targeted rejection percentage. In some embodiments, the NF membrane may have a desired TDS rejection percentage of at least about 70%, or at least about 71%, or at least about 72%, or at least about 73%, or at least about 74%, or at least about 75%, or at least about 76%, or at least about 77%, or at least about 78%, or at least about 79%, or at least about 80%, or at least about 81%, or at least about 82%, or at least about 83%, or at least about 84%, or at least about 85%, or at least about 86%, or at least about 87%, or at least about 88%, or at least about 89%, or at least about 90%.

In some embodiments, the NF membrane may be treated, processed, or designed to provide a desired TDS rejection percentage that does not exceed a targeted rejection percentage. In some embodiments, the NF membrane may have a desired TDS rejection percentage that is no more than about 90%, or no more than about 89%, or no more than about 88%, or no more than about 87%, or no more than about 86%, or no more than about 85%, or no more than about 84%, or no more than about 83%, or no more than about 82%, or no more than about 81%, or no more than about 80%, or no more than about 79%, or no more than about 78%, or no more than about 77%, or no more than about 76%, or no more than about 75%, or no more than about 74%, or no more than about 73%, or no more than about 72%, or no more than about 71%, or no more than about 70%.

It is to be appreciated that the desired TDS rejection percentage may be imparted with a discrete value, or range of values, falling within any minimum and maximum values or ranges recited herein with reference to the desired TDS rejection percentage.

In some embodiments, the NF membrane may be treated, processed, or designed to have a desired alkalinity rejection percentage. In some embodiments, the NF membrane may be imparted with a desired alkalinity rejection percentage of at least about 70% to no more than about 90%, although the desired alkalinity rejection percentage may be somewhat less or somewhat greater than these values. For example, the NF membrane may be treated, processed, or designed to have a desired alkalinity rejection percentage of at least about 75% to no more than about 90%, or at least about 80% to no more than about 85%, or at least about 81% to no more than about 84%.

In some embodiments, the NF membrane may be treated, processed, or designed to provide a desired alkalinity rejection percentage that meets or exceeds a targeted rejection percentage. In some embodiments, the NF membrane may have a desired alkalinity rejection percentage of at least about 70%, or at least about 71%, or at least about 72%, or at least about 73%, or at least about 74%, or at least about 75%, or at least about 76%, or at least about 77%, or at least about 78%, or at least about 79%, or at least about 80%, or at least about 81%, or at least about 82%, or at least about 83%, or at least about 84%, or at least about 85%, or at least about 86%, or at least about 87%, or at least about 88%, or at least about 89%, or at least about 90%.

In some embodiments, the NF membrane may be treated, processed, or designed so as to provide a desired alkalinity rejection percentage that does not exceed a targeted rejection percentage. In some embodiments, the NF membrane may have a desired alkalinity rejection percentage that is no more than about 90%, or no more than about 89%, or no more than about 88%, or no more than about 87%, or no more than about 86%, or no more than about 85%, or no more than about 84%, or no more than about 83%, or no more than about 82%, or no more than about 81%, or no more than about 80%, or no more than about 79%, or no more than about 78%, or no more than about 77%, or no more than about 76%, or no more than about 75%, or no more than about 74%, or no more than about 73%, or no more than about 72%, or no more than about 71%, or no more than about 70%.

It is to be appreciated that the alkalinity rejection percentage may be imparted with a discrete value, or range of values, falling within any minimum and maximum values or ranges recited herein with reference to the alkalinity rejection percentage.

In some embodiments, the NF membrane may be treated, processed, or designed to produce a permeate stream having a desired pH value. In some embodiments, the NF membrane may produce a permeate stream with a pH of at least about 6.2 to no more than about 8.5, although the pH value of the permeate stream may be somewhat less than or greater than these values. For example, the NF membrane may produce a permeate stream imparted with a pH of about 6.5 to about 8.5, or about 6.8 to about 8.0, or about 6.8 to about 7.5. In some embodiments, the NF membrane may produce a permeate stream having a minimum permeate pH of at least about 6.5. In some embodiments, the NF membrane may produce a permeate stream having a permeate pH of at least about 6.8 and no more than about 7.5.

In some embodiments, the NF membrane may be treated, processed, or designed to provide a permeate stream having a pH value that meets or exceeds a targeted pH value. In some embodiments, the NF membrane may provide a permeate stream having a desired pH value of at least about 6.2, or at least about 6.3, or at least about 6.4, or at least about 6.5, or at least about 6.6, or at least about 6.7, or at least about 6.8, or at least about 6.9, or at least about 7.0, or at least about 7.1, or at least about 7.2, or at least about 7.5, or at least about 7.8.

In some embodiments, the NF membrane may be treated, processed, or designed to provide a permeate stream having a pH value that does not exceed a targeted pH value. In some embodiments, the NF membrane may have a desired pH value of no more than about 7.2, or no more than about 7.1, or no more than about 7.0, or no more than about 6.9, or no more than about 6.8, or no more than about 6.7, or no more than about 6.6, or no more than about 6.5, or no more than about 6.4.

In some instances, the NF membrane may be treated, processed, or designed to produce a permeate water stream imparted with substantially the same pH value, or the same pH value, as the inlet water provided to the water treatment system 100. In some cases, the NF membrane may be treated, processed, or designed to produce a permeate water stream imparted with substantially the same pH value, or the same pH value, as the prefiltered water provided to the membrane elements 134-135. In some embodiments, the NF membrane may be treated, processed, or designed to minimally alter the pH value of the water stream processed by the NF membrane. In other embodiments, the NF membrane may be treated, processed, or designed to produce a permeate water stream imparted with the same pH value as the water stream provided to the NF membrane.

It is to be appreciated that the targeted pH value may be imparted with a discrete value, or range of values, falling within any minimum and maximum values or ranges recited herein with reference to the targeted pH value.

In some embodiments, the NF membrane may be treated, processed, or designed to have a desired membrane permeance while further achieving one or more of the disclosed calcium rejection percentage, total hardness rejection percentage, TDS rejection percentage, alkalinity rejection percentage, pollutant removal percentage, permeate stream pH value, and calculated LSI/CPP values (and/or other index values). In some embodiments, the NF membrane material may be imparted with a membrane permeance of at least about 13 LMBH to about 20 LMBH, although the membrane permeance may be somewhat less than or even greater than these values. For example, the NF membrane may be imparted with a membrane permeance of about 15 LMBH to about 20 LMBH, or about 17 LMBH to about 20 LMBH. In some embodiments, the NF membrane is designed to achieve a maximum membrane permeance while achieving specified rejection rates, for example, a maximum membrane permeance at a calcium rejection percentage of at least about 75%, or a maximum membrane permeance at a calcium rejection percentage of at least about 90%.

In some embodiments, the NF membrane may be treated, processed, or designed to have a desired membrane permeance that meets or exceeds a targeted membrane permeance while further achieving one or more of the disclosed calcium rejection percentage, total hardness rejection percentage, TDS rejection percentage, alkalinity rejection percentage, pollutant removal percentage, permeate stream pH value, and calculated LSI/CPP values (and/or other index values). In some embodiments, the NF membrane material may have a desired membrane permeance of at least about 13 LMBH, or at least about 14 LMBH, or at least about 15 LMBH, or at least about 16 LMBH, or at least about 17 LMBH, or at least about 18 LMBH, or at least about 19 LMBH, or at least about 20 LMBH, or even greater.

It is to be appreciated that the targeted membrane permeance may be imparted with a discrete value, or range of values, falling within any minimum and maximum values or ranges recited herein with reference to the targeted membrane permeance.

In some embodiments, the NF membrane may be treated, processed, or designed to have a desired permeate flow rate while further achieving one or more of the disclosed calcium rejection percentage, total hardness rejection percentage, TDS rejection percentage, alkalinity rejection percentage, pollutant removal percentage, permeate stream pH value, and calculated LSI/CPP values (and/or other index values). By way of non-limiting example, the NF membrane module may be constructed to have a 4-inch diameter, producing a permeate flow rate of 5 GPM to about 8 GPM, although the permeate flow rate may be somewhat less or even greater than these values. In various instances, the NF membrane module may produce a flow rate of greater than about 8 GPM. In some embodiments, the NF membrane may be treated, processed, or designed to have a desired permeate flow rate of at least about 14.5 GPM/ft³ of membrane.

In some embodiments, the NF membrane may be treated, processed, or designed to have a desired permeate flow rate that exceeds a targeted permeate flow rate while further achieving one or more of the disclosed calcium rejection percentage, total hardness rejection percentage, TDS rejection percentage, alkalinity rejection percentage, pollutant removal percentage, permeate stream pH value, and calculated LSI/CPP values (and/or other index values). In some embodiments, the NF membrane module may be constructed to have a 4-inch diameter producing a desired permeate flow rate of at least about 5 GPM, or at least about 6 GPM, or at least about 7 GPM, or at least about 8 GPM, or greater. In some embodiments, the NF membrane may be treated, processed, or designed to have a desired permeate flow rate of at least about 14.5 GPM/ft³ of membrane.

In some embodiments, the NF membrane may be treated, processed, or designed to have a desired membrane permeance while further achieving the disclosed TDS rejection percentage. In some embodiments, the NF membrane may have a membrane permeance of at least about 13 LMH/bar to no more than about 20 LMH/bar, or greater.

In some embodiments, the NF membrane may be treated, processed, or designed to have a desired membrane permeance that meets or exceeds a targeted membrane permeance while further achieving the disclosed TDS rejection percentage. In some embodiments, the NF membrane may have a desired membrane permeance that is at least about 13 LMBH, or at least about 14 LMBH, or at least about 15 LMBH, or at least about 16 LMBH, or at least about 17 LMBH, or at least about 18 LMBH, or at least about 19 LMBH, or at least about 20 LMBH, or even greater.

In some embodiments, the NF membrane may be treated, processed, or designed to have a desired permeate flow rate while further achieving the disclosed TDS rejection percentage. In some embodiments, the NF membrane may have a permeate flow rate of at least about 5 GPM to no more than about 8 GPM, although the permeate flow rate may be somewhat less or even greater than these values.

In some embodiments, the NF membrane may be treated, processed, or designed to have a desired permeate flow rate that meets or exceeds a targeted permeate flow rate while further achieving the disclosed TDS rejection percentage. In some embodiments, the NF membrane may have a desired permeate flow rate of at least about 5 GPM, or at least about 6 GPM, or at least about 7 GPM, or at least about 8 GPM, or greater.

In some embodiments, the NF membrane element including the above-described NF membrane may produce a permeate water stream imparted with desired parameters or characteristics (e.g., a balanced permeate water or a balanced permeate stream). For example, the permeate water stream may be imparted with a calcium ion concentration that is about 60% to about 90% less than a calcium ion concentration of the inlet water provided to the water treatment system 100, a total hardness level that is about 75% to about 90% less than a total hardness level of the inlet water provided to the water treatment system 100, a TDS level that is about 70% to about 90% less than the TDS level of the inlet water provided to the water treatment system 100, an alkalinity value that is about 75% to about 90% less than the alkalinity value of the inlet water provided to the water treatment system 100, and/or a pH level of about 6.2 to about 8.5. As an additional example, the permeate water may be imparted with a calcium ion concentration that is about 81% to about 84% less than a calcium ion concentration of the inlet water provided to the water treatment system 100, a total hardness level that is about 81% to about 84% less than a total hardness level of the inlet water provided to the water treatment system 100, a TDS level that is about 81% to about 84% less than the TDS level of the inlet water provided to the water treatment system 100, an alkalinity value that is about 81% to about 84% less than the alkalinity value of the inlet water provided to the water treatment system 100, and/or a pH level of about 6.5 to about 7.0. In some such instances, the NF membrane may be treated, processed, or designed to have a desired membrane permeance of about 13 LMBH to about 20 LMBH, or about 17 LMBH to about 20 LMBH while also producing the balanced permeate water, although the desired membrane permeance may be greater than these values. In further such instances, the permeate water stream provided from the membrane elements 134-135 may be imparted with a permeate flow rate of about 5 GPM to about 8 GPM, although the flow rate may be even greater than these values.

Further tuning of the water chemistry of water provided from the water treatment system 100 (e.g., an outlet water stream) may be accomplished through other means in conjunction with the NF membrane. By way of non-limiting example, further tuning or adjusting of the water chemistry of the outlet water stream may be accomplished via remineralization, dosing a chemical compound to the permeate water stream or the outlet water stream, and/or feed blending.

In some embodiments, the NF membrane may be treated, processed, or designed to remove pollutants (e.g., micro-pollutants, heavy metals, etc.), while further achieving one or more of the disclosed calcium rejection percentage, total hardness rejection percentage, TDS rejection percentage, alkalinity rejection percentage, permeate stream pH value, and calculated LSI/CPP values (and/or other index values). In some embodiments, the NF membrane may remove micro-pollutants including, for example, per- and polyfluoroalkyl substances (PFAS), commonly referred to as “forever chemicals.” Representative PFAS compounds that may be removed with the NF membrane may include perfluorobutane sulfonate (PFBS), perfluorohexanesulfonic acid (PFHxS), perfluorooctanoic acid (PFOA), perfluorooctane sulfonic acid (PFOS), perfluorodecanoic acid (PFDA), perfluoroheptanoic acid (PFHpA), and/or perfluorononanoic acid (PFNA). The NF membrane may be treated, processed, or designed to remove at least about 95% to about 100% of total PFAS compounds present in the inlet water provided to the water treatment system 100. In other instances, the NF membrane may be treated, processed, or designed to remove at least about 95% to about 100% of total PFAS compounds present in the prefiltered water provided to the membrane elements 134-135. For example, the NF membrane may be treated, processed, or designed to remove at least about 95%, or at least about 96%, or at least about 97%, or at least about 98%, or at least about 99%, or at least about 99.5%, or at least about 99.9%, or about 100% of total PFAS compounds present in the inlet water and/or the prefiltered water provided to the membrane elements 134-135.

In some embodiments, the NF membrane may be treated, processed, or designed to remove pollutants, for example, heavy metals, while further achieving one or more of the disclosed calcium rejection percentage, total hardness rejection percentage, TDS rejection percentage, alkalinity rejection percentage, permeate stream pH value, and calculated LSI/CPP values (and/or other index values). In some embodiments, the NF membrane may remove heavy metals including, for example, copper, lead, arsenic, chromium, and iron. The NF membrane may be treated, processed, or designed to remove at least about 70%, or at least about 80%, or at least about 85%, or at least about 90%, or more than 95% of the heavy metals present in the inlet water provided to the water treatment system 100. The NF membrane may be treated, processed, or designed to remove at least about 70%, or at least about 80%, or at least about 85%, or at least about 90%, or more than 95% of the heavy metals present in the prefiltered water provided to the membrane elements 134-135. In further instances, the NF membrane may be treated, processed, or designed to remove substantially all or all of the heavy metals from a water stream provided to the NF membrane. For example, the NF membrane may be treated, processed, or designed to remove or at least about 70%, or at least about 75%, or at least about 80%, or at least about 85%, or at least about 90%, or at least about 95%, or at least about 96%, or at least about 97%, or at least about 98%, or at least about 99%, or about 100% of the heavy metals present in the water provided to the membrane elements 134-135 (e.g., the prefiltered water or the inlet water provided to the water treatment system 100).

In some embodiments, operation of the water treatment system 100 may be tailored to provide desired permeate characteristics when the membrane elements 134-135 comprises the disclosed NF membrane. In some cases, rejection characteristics of the membrane elements 134-135 may be selectively adjusted, for example, by adjusting a recovery of the water treatment system 100 with a flow restrictor tube and/or an adjustable flow retentate valve (e.g., a needle valve). Generally, by selectively increasing a recovery percentage of the water treatment system 100, levels of calcium, total hardness levels (e.g., Ca²⁺ and Mg²⁺ ion concentrations), and/or a TDS level may be increased to a desired level to achieve a desired balance for the permeate stream (e.g., a permeate water imparted with a desired taste, a permeate water exhibiting reduced or no scale formation downstream of the membrane elements 134-135). Representative, non-limiting examples for operating water treatment system 100 using a transmembrane pressure differential of 150 psi are illustrated in the Table below.

TABLE 2
Recovery Percentage vs. TDS Rejection Percentage

| | Flow Rate | Recovery | TDS Rejection |
|---|---|---|---|
| Example | (gpm @ 25° C.) | Percentage | Percentage |
| 1 | 4.72 | 49.71 | 89.81 |
| 2 | 4.38 | 79.72 | 73.74 |
| 3 | 4.07 | 90.51 | 61.99 |

Thus, as shown in Table 2, the performance of the treated, processed, or designed NF membrane element may be further tailored when used in the water treatment system 100, such that a balanced or desired permeate water stream can be produced.

In embodiments of the water treatment system 100 in which the membrane elements 134-135 comprises the disclosed NF membrane, various design changes may be incorporated into the water treatment system 100 to reduce system complexity and cost of the water treatment system 100. In some embodiments of the water treatment system 100 utilizing the treated, processed, or designed NF membrane, various post-treatment elements may no longer be desired or necessary. For example, when the NF membrane has been treated to provide the disclosed calcium, total hardness and/or TDS rejection percentages, the resulting permeate stream may be imparted with taste characteristics that reduce or eliminate the need for a post-filtration remineralization unit. This may especially be true in instances where the source water is an aquifer that may have naturally elevated levels of calcium and TDS.

In other embodiments, when the NF membrane has been treated, processed, or designed to provide a desired pH range for the permeate stream, post-treatment pH adjustment for the permeate stream may be lessened or completely eliminated. In some embodiments, when the NF membrane has been treated to provide a desired membrane permeance and/or permeate flow rate, the membrane elements 134-135 may be constructed with a lower membrane surface area and/or a smaller overall footprint, thereby reducing manufacturing costs of the membrane elements 134-135 and easing the installation of the membrane elements 134-135 in residential settings. In some embodiments, the NF membrane may allow for use of a smaller pump and/or lower pump pressure in the water treatment system 100, while still producing similar water output compared to an RO system.

It is to be understood that, while the treated, processed, or designed NF membrane discussed above has been described with reference to the membrane elements 134-135 and the water treatment system 100, the NF membrane element may be used as part of any of the membrane elements and water treatment systems (e.g., a water treatment system 190), and variations thereof, described herein.

In addition, the treated, processed, or designed NF membrane described above may be used in other membrane filtration systems that do not utilize flow-through tanks. For instance, said NF membranes may be used in membrane filtration systems that utilize atmospheric storage tanks or bladder tanks. Additionally, the NF membrane can be utilized in systems that do not utilize permeate storage tanks, which are also known as “tankless” systems.

The first membrane element 134 may be in fluid communication with the membrane feed line 132. The first membrane element 134 may generate permeate and retentate. The permeate from the first membrane element 134 may flow to a post-filtration subsystem 150 included in the processor subsystem 101. The retentate from the first membrane element 134 may flow to the second membrane element 135. The second membrane element 135 may generate permeate and retentate. The permeate from the second membrane element 135 may flow to the post-filtration subsystem 150. The retentate from the second membrane element 135 may flow to the drain 141. The permeate produced by the first membrane element 134 and the permeate produced by the second membrane element 135 may collectively be referred to as membrane filtered water. The membrane filtered water can flow from the first membrane element 134 and the second membrane element 135 to a membrane permeate line 138 fluidly coupled to the first membrane element 134 and the second membrane element 135.

In some embodiments, the first membrane element 134 and/or the second membrane can be nanofiltration elements. In some embodiments, the water treatment system 100 can include a single nanofiltration membrane element. In some embodiments where there is a single nanofiltration membrane element or both the first membrane element 134 and the second membrane are nanofiltration elements, the water treatment system 100 may not include the one or more mineralization cartridges 150.

The second membrane element 135 can also be fluidly coupled to the drain 141 via a retentate line 136 included in the water treatment system 100. Retentate from the second membrane element 135 can flow to the drain 141 via the retentate line 136.

The water treatment system 100 may include a flow restrictor 143 that may be in fluid communication with the retentate line 136. The flow restrictor 143 may restrict the flow of the retentate in the retentate line 136.

The water treatment system 100 may include one or more flowmeters 114a-c. In some embodiments, the one or more flowmeters 114a-c may be provided as a mechanical flowmeter or an ultrasonic flowmeter. In some embodiments, the one or more flowmeters may include a ⅜ inch (0.95 centimeter) F-nut inflow connector, a ⅜ inch (0.95 centimeter) M nut outflow connector, an operating pressure range of approximately 29-116 pounds per square inch (PSI) (2-8 bar), an operating flow rate of 3-26 gallons per hour (GPH) (10-100 liters per hour), a pressure loss of 3 PSI (0.2 bar) at 26 GPH, a precision (horizontal installation) of +/−5% or more, a water temperature operating range of approximately 39-86° F. (4-30° C.), and/or an ambient temperature operating range of approximately 39-120° F. (4-50° C.). In other embodiments, the one or more flowmeters 114 may be a 0.26-16 GPM (1-60.5 LPM) turbine flowmeter, a 0.26-7.9 GPM (1-29.9 LPM) turbine flowmeter, or a 0.26-0.65 GPM (1-2.5 LPM) turbine flowmeter. One of ordinary skill in the art would understand that each of the one or more flowmeters 114a-114c may be the same type of flowmeter or may each be a different type of flowmeter.

The water treatment system 100 may include a first flowmeter 114a that may be in fluid communication with the retentate line 136. The first flowmeter 114a may measure, monitor, or sense the flow rate of the retentate in retentate line 136.

The water treatment system 100 may include a third TDS sensor 116c. The third TDS sensor 116c may be in fluid communication with the permeate line 138. The third TDS sensor 116c may measure, monitor, or sense the conductivity of the membrane filtered water to determine an amount or concentration of dissolved solids in the membrane filtered water.

In some embodiments, the water treatment system 100 may also include one or more mineralization cartridges 150. As shown, the water treatment system 100 may include a first mineralization cartridge 150a, a second mineralization cartridge 150b, a third mineralization cartridge 150c, and a fourth mineralization cartridge 150d. The mineralization cartridges 150a-d may be in fluid communication with the permeate line 138. The mineralization cartridges 150a-d can each contain a mineralization material. In some embodiments, each of the mineralization cartridges 150a-d may contain the same material. In some embodiments, each of the mineralization cartridges 150a-d may not contain the same material.

The mineralization material may be provided as a calcium-containing compound or a magnesium-containing compound, although other ionic compounds could also be used to increase the mineral or TDS concentration of the membrane filtered water. The mineralization material may be, for example, a calcium carbonate compound (CaCO₃), a magnesium carbonate compound (MgCO₃), a magnesium oxide compound (MgO), a calcium oxide compound (CaO), a sodium bicarbonate compound (NaHCO₃), dolomite (CaMg(CO₃)₂), other substances with similar chemical and physical properties, and combinations thereof. In some instances, the mineralization compound may be selected from the group consisting of a calcium carbonate compound (CaCO₃), a magnesium carbonate compound (MgCO₃), a magnesium oxide compound (MgO), a calcium oxide compound (CaO), a sodium bicarbonate (Na₂CO₃) compound, a sodium bicarbonate compound (NaHCO₃), a potassium carbonate (K₂CO₃) compound, a potassium bicarbonate (KHCO₃) compound, dolomite (CaMg(CO₃)₂), and combinations thereof. In instances where the mineralization material includes a calcium carbonate compound, the calcium carbonate may be provided in the form of calcite. In some instances, a magnesium oxysulfate compound may be used as the mineralization material.

The mineralization cartridges 150a-d can be fluidly coupled to a remineralization line 145 included in the water treatment system 100. Water from the mineralization cartridges 150a-d may be referred to as mineralized water and/or remineralized water. The remineralized water can flow to the outlet line 146 via the remineralization line 145.

The remineralized water that exits or results from passing by or through the mineralization cartridges 150a-d may be imparted with a TDS concentration of at least about 20 ppm to at least about 1000 ppm, or at least about 50 ppm to at least about 500 ppm, or at least about 100 ppm to at least about 400 ppm. In some instances, the remineralized water that exits or results from passing by or through the mineralization cartridges 150a-d may be imparted with a TDS concentration less than about 20 ppm or greater than about 1000 ppm. In some instances, it is preferred to impart the remineralized water with a TDS concentration of at least about 50 ppm or at least 50 ppm.

The water treatment system 100 may include a fourth TDS sensor 116d. The fourth TDS sensor 116d may be in fluid communication with the remineralization line 145. The fourth TDS sensor 116d may measure, monitor, or sense the conductivity of the remineralized water to determine an amount or concentration of dissolved solids in the remineralized water.

The water treatment system 100 may include a second flowmeter 114b that may be in fluid communication with the remineralization line 145. The second flow meter 114b may measure, monitor, or sense the flow rate of the remineralized water in remineralization line 145.

The water treatment system 100 may include a first check valve 149. The first check valve 149 may be in fluid communication with the remineralization line 145 and the outlet feed line 146. The first check valve 149 can prevent fluid from the outlet feed line 146 from flowing toward the mineralization cartridges 150a-d. In some embodiments, the first check valve 149 can be a backflow preventer or other type of valve that provides one-way flow.

The remineralization line 145 may be connected to or otherwise in fluid communication with the tank line 144. The tank line 144 may be in fluid communication with the top portion 118c of the tank 118. The tank line 144 also may be connected to or otherwise in fluid communication with the outlet feed line 146. The outlet feed line 146 may be in fluid communication with the outlet 148 of the water treatment system 100.

In some embodiments, depending on the flow conditions when the water treatment system 100 is in use, the remineralized water may flow from the fourth mineralization cartridge 150d through the remineralization line 145 and the tank line 144 into the top portion 118c of the tank 118. The remineralized water may be stored in the tank 118. The remineralized water may also flow from the remineralization line 145 to the tank line 144, into the outlet feed line 146 (thereby bypassing the tank 118), and out of the outlet 148. By enabling the flow of remineralized water from the mineralization cartridges 150a-d directly to the outlet 148, remineralized water may be provided to a point of use in real time.

Due to the amount of dissolved ions in high TDS water, high TDS water tends to have a higher density than low TDS water. By sending higher TDS water (e.g., the prefiltered water) to the bottom portion 118a of the tank 118 and lower TDS water (e.g., the remineralized water) to the top portion 118c of the tank 118, the chances of water with different TDS amounts or concentrations mixing inside the tank 118 may be minimized. Thus, when remineralized water is drawn from the top portion 118c of the tank 118, low TDS water may be provided to a point of use. Sending higher TDS water to the bottom of the tank 118 and lower TDS water to the top of the tank 118 may also create a sharp TDS profile along the vertical height of the tank 118, where the amount or concentration of TDS at the bottom portion 118a of the tank 118 is the highest (e.g., a TDS concentration of more than about 2 grains per gallon (34 milligrams per liter)), and the amount or concentration of TDS at the top portion 118c of the tank 118 is the lowest (e.g., a TDS concentration of less than about 2 grains per gallon (34 milligrams per liter)). Creating and maintaining this sharp TDS profile is aided by the density difference between the high TDS water and the low TDS water.

The remineralized water and/or the prefiltered water that may be stored in the tank 118 may flow through the tank line 144 and the outlet feed line 146 out of the outlet 148. The outlet 148 may be in fluid communication with various appliances, fixtures, and plumbing of the residential or commercial property. In some embodiments, the outlet 148 may be in fluid communication with a water heater, faucets, fixtures, or toilets via one or more pipes or tubes.

The water treatment system 100 may include a third flowmeter 114c that may be in fluid communication with the outlet feed line 146. The third flowmeter 114c may measure, monitor, or sense the flow rate of the remineralized water and/or the prefiltered water in the outlet feed line 146.

The outlet feed line 146 may be in fluid communication with a fourth pressure sensor 106d. The fourth pressure sensor 106d may measure, monitor, or sense the pressure of the remineralized water and/or the prefiltered water in the outlet feed line 146.

The water treatment system 100 may include a fifth TDS sensor 116e. The fifth TDS sensor 116e may be in fluid communication with the outlet feed line 146. The fifth TDS sensor 116e may measure, monitor, or sense the conductivity of the remineralized water and/or the prefiltered water in the outlet feed line 146 to determine an amount or concentration of dissolved solids in the remineralized water and/or the prefiltered water.

The water treatment system 100 may include a sixth TDS sensor 116f. The sixth TDS sensor 116f may be in fluid communication with the tank 118. In some embodiments, the sixth TDS sensor 116f may be positioned between the top portion 118c and the center portion 118b of the tank 118. In some embodiments, the sixth TDS sensor 116f can positioned at about 80 percent of the height and/or capacity of the tank. The sixth TDS sensor 116f may measure, monitor, or sense the conductivity of the water in the tank at or around the position of the sixth TDS sensor 116f. The sixth TDS sensor 116f can be used to determine if the tank 118 is substantially depleted of remineralized water. For example, if the sensor generates a TDS value indicative of the presence of prefiltered water, the tank 118 may be contain less than 20 percent remineralized water.

The water treatment system 100 may include a third actuated valve 153. The third actuated valve 153 may be in fluid communication with a membrane flush line 154. The membrane flush line 154 may be in fluid communication with the tank line 144 and the outlet feed line 146. The third actuated valve 153 may be a gate valve. In some embodiments, the third actuated valve 153 may be a butterfly valve, a ball valve, or a globe valve. The third actuated valve 153 may control or regulate the amount of remineralized water and/or prefiltered water in the membrane flush line 154 provided to the pump 130 for flushing the membranes. The third actuated valve 153 may open, either partially or fully, to enable the flow or increase the amount of remineralized water and/or prefiltered water provided to the pump 130. The third actuated valve 153 may close, either partially or fully, to stop or decrease the amount of remineralized water and/or prefiltered water provided to the pump 130.

The water treatment system 100 may include one or more valves in fluid communication with the drain 141. The water treatment system 100 may include a fourth actuated valve 158 in fluid communication with the remineralization line 145 and the drain 141. The water treatment system 100 may include the fifth actuated valve 160 in fluid communication with the additive line 126, the prefilter flush line 161, and the drain 141. The fifth actuated valve 160 may be in fluid communication with a second check valve 162. The second check valve 162 can prevent fluid from the drain 141 from flowing toward the additive line 126. In some embodiments, the second check valve 162 can be a backflow preventer or other type of valve that provides one-way flow.

In some embodiments, the fourth actuated valve 158 may be a gate valve. In some embodiments, the fourth actuated valve 158 may be a butterfly valve, a ball valve, or a globe valve. The fourth actuated valve 158 may be an electric valve.

In some embodiments, the fifth actuated valve 160 may be a gate valve. In some embodiments, the fifth actuated valve 160 may be a butterfly valve, a ball valve, or a globe valve. The fifth actuated valve 160 may be an electric valve.

The fourth actuated valve 158 and the fifth actuated valve 160 may open, either partially or fully, to allow fluid from the remineralization line 145 and the additive line 126 to flow to the drain 141, while also allowing the water treatment system 100 to depressurize. The fourth actuated valve 158 and the fifth actuated valve 160 may close, either partially or fully, when the depressurization is complete.

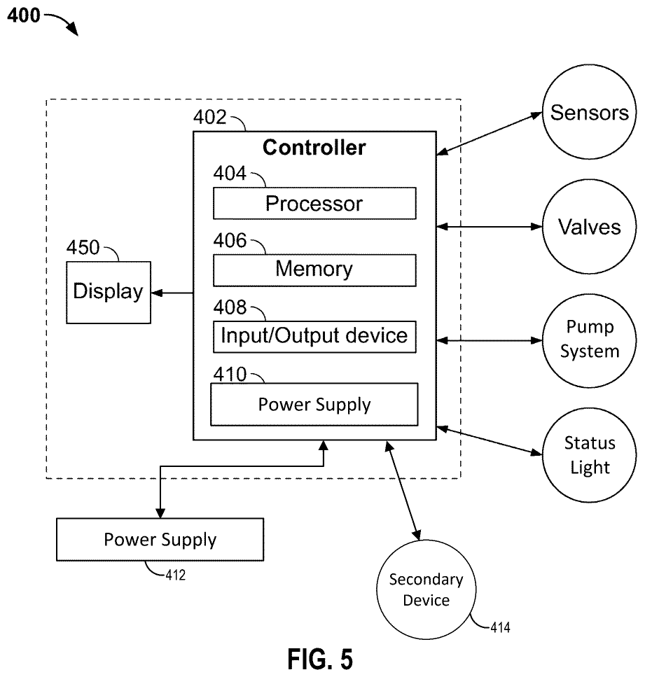

The water treatment system 100 may include and be in communication with a control system 400. The control system 400 may include the controller 402 and a display 450. As shown in FIG. 5, the controller 402 may be electronically connected to and may be in electronic communication with the display 450. The controller 402 also may be electronically connected to and may be in electronic communication with one or more of the water treatment system components including the one or more sensors (106a-106d, 114a-114c, and 116a-116f), the first, second, third, fourth, or fifth actuated valves (108, 129, 153, 158, and 160, respectively), and/or the pump 130. In some embodiments, the remineralization line 145, the additive line 126, the prefilter flush line 161, the membrane flush line 154, the tank line 144, the outlet feed line 146, the permeate line 138, the retentate line 136, the membrane feed line 132, the prefiltered water line 112, and the inlet line 104 may collectively form a conduit of the water treatment system 100.

FIG. 1B illustrates an embodiment of another water treatment system 190. In some embodiments, the water treatment system 190 can include some or all of the components included in the water treatment system 100 in FIG. 1A. The water treatment system 190 in FIG. 1B can also include additional components not illustrated in FIG. 1A.

The water treatment system can include a plurality of outlets 148a-n. In some embodiments, the water treatment system 190 can include a first outlet 148a and a second outlet 148b. The inclusion of multiple outlets can be helpful for installation in facilities that have multiple main water line branches. For example, the first outlet 148a can be coupled to a first floor of a rental property and the second outlet 148b can be coupled to a second floor of the rental property. In some embodiments, the plurality of outlets 148a-n can include three outlets, four outlets, five outlets, six outlets, seven outlets, eight outlets, nine outlets, and/or ten outlets.

In some embodiments, the water treatment system 190 can include one or more valves 164a-n. In some embodiments, one or more of the plurality of outlets 148a-n can be coupled to and in communication with a valve. For example, the first outlet 148a can be coupled to and in fluid communication with a first outlet valve 164a and the second outlet 148b can be coupled to and in fluid communication with a second outlet valve 164b. The first outlet valve 164a and the second outlet valve 164b can be coupled to and in fluid communication with the outlet line 146 and fluidly couple the first outlet 148a and the second outlet 148b to the outlet line 146. In some embodiments, one or more of the one or more valves 164a-n can be manual valves. In some embodiments, one or more of the one or more valves 164a-n can be actuated valves. In some embodiments, one or more of the one or more valves 164a-n may be a gate valve. In some embodiments, one or more of the one or more valves 164a-n may be a butterfly valve, a ball valve, and/or a globe valve. One or more of the one or more valves 164a-n may be an electric valve. One or more of the one or more valves 164a-n can be coupled to and in communication with the control system 400.

The water treatment system 190 can also include one or more line-specific outlets for providing alterative outlet options to a user. In some embodiments, the water treatment system 190 can include a prefiltered water line outlet 171, an additive line outlet 174, and/or a membrane permeate line output 177. In this way, the water treatment system 190 can provide different levels of purification and/or TDS level water to different applications.

In some embodiments, the prefiltered water line outlet 171 can be coupled to and in fluid communication with the prefiltered water line 112 via a prefiltered water branch line 170 included in the water treatment system 190. In some embodiments, the water treatment system 190 can include a prefiltered water branch line valve 172. In some embodiments, the prefiltered water branch line valve 172 can be coupled between the prefiltered water line outlet 171 and the prefiltered water line 112. The prefiltered water branch line valve 172 can control fluid flow between the prefiltered water line 112 and the prefiltered water line outlet 171 along the prefiltered water branch line 170.

In some embodiments, the prefiltered water branch line valve 172 can be a manual valve. In some embodiments, the prefiltered water branch line valve 172 can be an actuated valve. In some embodiments, the prefiltered water branch line valve 172 can be a gate valve. In some embodiments, the prefiltered water branch line valve 172 can be a butterfly valve, a ball valve, and/or a globe valve. The prefiltered water branch line valve 172 can be an electric valve. The prefiltered water branch line valve 172 can be coupled to and in communication with the control system 400.

In some embodiments, the additive line outlet 174 can be coupled to and in fluid communication with the additive line 126 via an additive branch line 173 included in the water treatment system 190. In some embodiments, the water treatment system 190 can include an additive branch line valve 175. In some embodiments, the additive branch line valve 175 can be coupled between the additive line outlet 174 and the additive line 126. The additive branch line valve 175 can control fluid flow between the additive line 126 and the additive line outlet 174 along the additive branch line 173.

In some embodiments, the additive branch line valve 175 can be a manual valve. In some embodiments, the additive branch line valve 175 can be an actuated valve. In some embodiments, the additive branch line valve 175 can be a gate valve. In some embodiments, the additive branch line valve 175 can be a butterfly valve, a ball valve, and/or a globe valve. The additive branch line valve 175 can be an electric valve. The additive branch line valve 175 can be coupled to and in communication with the control system 400.

In some embodiments, the membrane permeate line output 177 can be coupled to and in fluid communication with the membrane permeate line 138 via a permeate branch line 176 included in the water treatment system 190. In some embodiments, the water treatment system 190 can include a membrane permeate branch line valve 178. In some embodiments, the membrane permeate branch line valve 178 can be coupled between the membrane permeate line outlet 177 and the membrane permeate line 138. The membrane permeate branch line valve 178 can control fluid flow between the membrane permeate line 138 and the membrane permeate line outlet 177 along the membrane permeate branch line 176

In some embodiments, the membrane permeate branch line valve 178 can be a manual valve. In some embodiments, the membrane permeate branch line valve 178 can be an actuated valve. In some embodiments, the membrane permeate branch line valve 178 can be a gate valve. In some embodiments, the membrane permeate branch line valve 178 can be a butterfly valve, a ball valve, and/or a globe valve. The membrane permeate branch line valve 178 can be an electric valve. The membrane permeate branch line valve 178 can be coupled to and in communication with the control system 400.

The water treatment system 190 can also include a leak detection sensor 180. In some embodiments, the leak detection sensor 180 can be a wetness sensor. The leak detection sensor 180 can be positioned within and/or coupled to the processor subsystem 101 and configured to detect moisture in the processor subsystem 101. In some embodiments, the leak detection sensor 180 can be coupled to a drip tray located under one or more components included in the processor subsystem 101.

The water treatment system 190 can also include a temperature sensor 182. In some embodiments, the temperature sensor 182 can be configured to sense a temperature of water at or near the inlet 102. The temperature sensor 182 can be positioned within and/or coupled to the processor subsystem 101.

The control system 400 can be coupled to and in communication with the leak detection sensor 180 and/or the temperature sensor 182.

In some embodiments, the water treatment system 190 can include some or all of the components included in the water treatment system 100 in FIG. 1A and the leak detection sensor 180 shown in FIG. 1B. In some embodiments, the water treatment system 190 can include all of the components included in the water treatment system 100 in FIG. 1A and the leak detection sensor 180 shown in FIG. 1B.

In some embodiments, the water treatment system 190 can include some or all of the components included in the water treatment system 100 in FIG. 1A and the temperature sensor 182 shown in FIG. 1B. In some embodiments, the water treatment system 190 can include all of the components included in the water treatment system 100 in FIG. 1A and the temperature sensor 182.

In some embodiments, the remineralization line 145, the additive line 126, the prefilter flush line 161, the membrane flush line 154, the tank line 144, the outlet feed line 146, the permeate line 138, the retentate line 136, the membrane feed line 132, the prefiltered water line 112, the inlet line 104, the prefiltered water branch line 170, the additive branch line 173, and the permeate branch line 176 may collectively form a conduit of the water treatment system 190.

In some embodiments, the water treatment system 190 can include some or all of the components included in the water treatment system 100 in FIG. 1A, the leak detection sensor 180 shown in FIG. 1B, and one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177. In some embodiments, the water treatment system 190 can include all of the components included in the water treatment system 100 in FIG. 1A, the leak detection sensor 180 shown in FIG. 1B, and one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177.

In some embodiments, the water treatment system 190 can include some or all of the components included in the water treatment system 100 in FIG. 1A, the temperature sensor 182 shown in FIG. 1B, and one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177. In some embodiments, the water treatment system 190 can include all of the components included in the water treatment system 100 in FIG. 1A, the temperature sensor 182 shown in FIG. 1B, and one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177.

In some embodiments, the water treatment system 190 can include some or all of the components included in the water treatment system 100 in FIG. 1A and one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177. In some embodiments, the water treatment system 190 can include all of the components included in the water treatment system 100 in FIG. 1A and one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177.

In some embodiments, the water treatment system 190 can include some or all of the components included in the water treatment system 100 in FIG. 1A, the leak detection sensor 180 and the temperature sensor 182 shown in FIG. 1B, and one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177. In some embodiments, the water treatment system 190 can include all of the components included in the water treatment system 100 in FIG. 1A, the leak detection sensor 180 and the temperature sensor 182 shown in FIG. 1B, and one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177.

In some embodiments, the water treatment system 190 can include a single outlet (e.g., the outlet 148 in FIG. 1A or the first outlet 148a in FIG. 1B), the leak detection sensor 180 shown in FIG. 1B, one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177, and some or all of the components included in the water treatment system 100 in FIG. 1A other than the outlet 148.

In some embodiments, the water treatment system 190 can include a single outlet (e.g., the outlet 148 in FIG. 1A or the first outlet 148a in FIG. 1B), the temperature sensor 182 shown in FIG. 1B, one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177, and some or all of the components included in the water treatment system 100 in FIG. 1A other than the outlet 148.

In some embodiments, the water treatment system 190 can include a single outlet (e.g., the outlet 148 in FIG. 1A or the first outlet 148a in FIG. 1B), the leak detection sensor 180 and the temperature sensor 182 shown in FIG. 1B, one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177, and some or all of the components included in the water treatment system 100 in FIG. 1A other than the outlet 148.

In some embodiments, the water treatment system 190 can include a single outlet (e.g., the outlet 148 in FIG. 1A or the first outlet 148a in FIG. 1B), one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177, and some or all of the components included in the water treatment system 100 in FIG. 1A other than the outlet 148.

In some embodiments, the water treatment system 190 can include a single outlet (e.g., the outlet 148 in FIG. 1A or the first outlet 148a in FIG. 1B), the leak detection sensor 180 shown in FIG. 1B, one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177, and all of the components included in the water treatment system 100 in FIG. 1A other than the outlet 148.

In some embodiments, the water treatment system 190 can include a single outlet (e.g., the outlet 148 in FIG. 1A or the first outlet 148a in FIG. 1B), the temperature sensor 182 shown in FIG. 1B, one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177, and all of the components included in the water treatment system 100 in FIG. 1A other than the outlet 148.

In some embodiments, the water treatment system 190 can include a single outlet (e.g., the outlet 148 in FIG. 1A or the first outlet 148a in FIG. 1B), the leak detection sensor 180 and the temperature sensor 182 shown in FIG. 1B, one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177, and all of the components included in the water treatment system 100 in FIG. 1A other than the outlet 148.

In some embodiments, the water treatment system 190 can include a single outlet (e.g., the outlet 148 in FIG. 1A or the first outlet 148a in FIG. 1B), one or more of the prefiltered water branch line 170, the prefiltered water branch line valve 172, the prefiltered water line outlet 171, the additive branch line 173, the additive branch line valve 175, the additive line outlet 174, the permeate branch line 176, the membrane permeate branch line valve 178, and/or the membrane permeate line outlet 177, and all of the components included in the water treatment system 100 in FIG. 1A other than the outlet 148.

In some embodiments, one or more additional and/or alternative water characteristic sensors can be positioned at or near one or more of the TDS sensors 116a-f in the water treatment system 100 of FIG. 1A and/or the water treatment system 190 of FIG. 1B. In some embodiments, the one or more additional and/or alternative water characteristic sensors can include one or more of a temperature sensor, an oxidation reduction potential (ORP) probe, a colorimeter sensor, an ion-selective electrode sensor, a volume-based batching sensor, and/or a pH sensor.

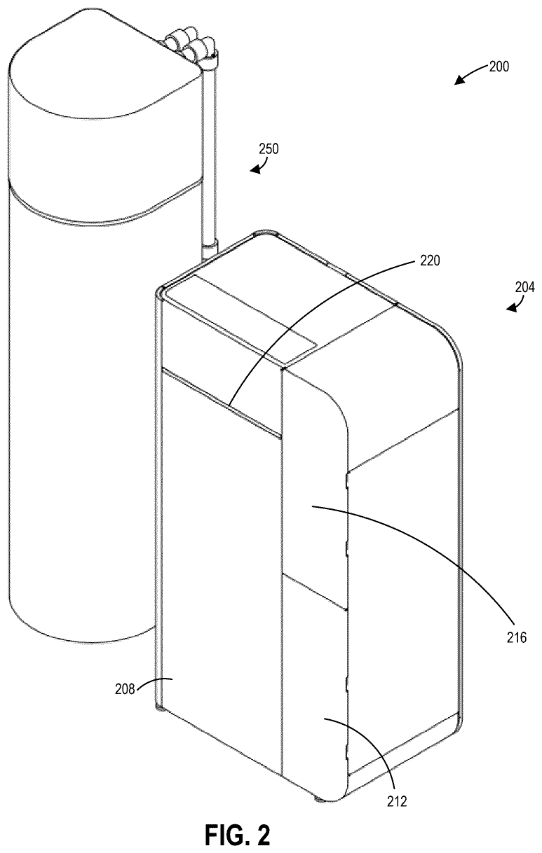

FIG. 2 is a perspective view of an enclosure system 200 configured to house components of the water treatment system 100 in FIG. 1A. The enclosure system 200 may include a processor enclosure 204 configured to house some or all of the components in the processor subsystem 101. The enclosure system 200 may include a tank enclosure 250 configured to house some or all of the components in the tank subsystem 117. In some embodiments, the enclosure system 200 may be configured to house some or all of the water treatment system 190 in FIG. 1B.

The processor enclosure 204 can include one or more doors configured to open and allow access to certain replaceable components included in the processor subsystem 101. The processor enclosure 204 can include a first door 208, a second door 212, and a third door 216. In some embodiments, one or more of the first door 208, the second door 212, and/or the third door 216 may be removable without tools.

The processor enclosure 204 can include a status light 220 coupled to the controller 402 in FIG. 1A and/or FIG. 1B. The status light 220 may include one or more LEDs. As will be described further below, the status light 220 can display a color that indicates whether the water treatment system 100 is in a normal state, a warning state, or an error state.

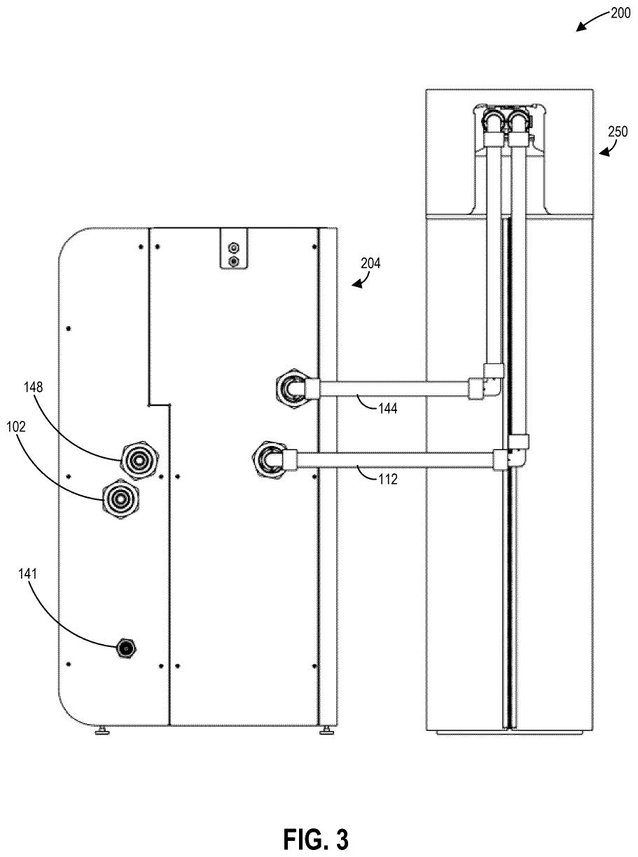

FIG. 3 is a rear view of the processor enclosure 204 of FIG. 2. As shown, components of the processor enclosure 204 are fluidly coupled to components of the tank enclosure 250 via the tank line 144 and the prefiltered water line 112. Furthermore, connections for the inlet 102, the outlet 148, and the drain line 141 are arranged on a rear face of the processor enclosure 204.

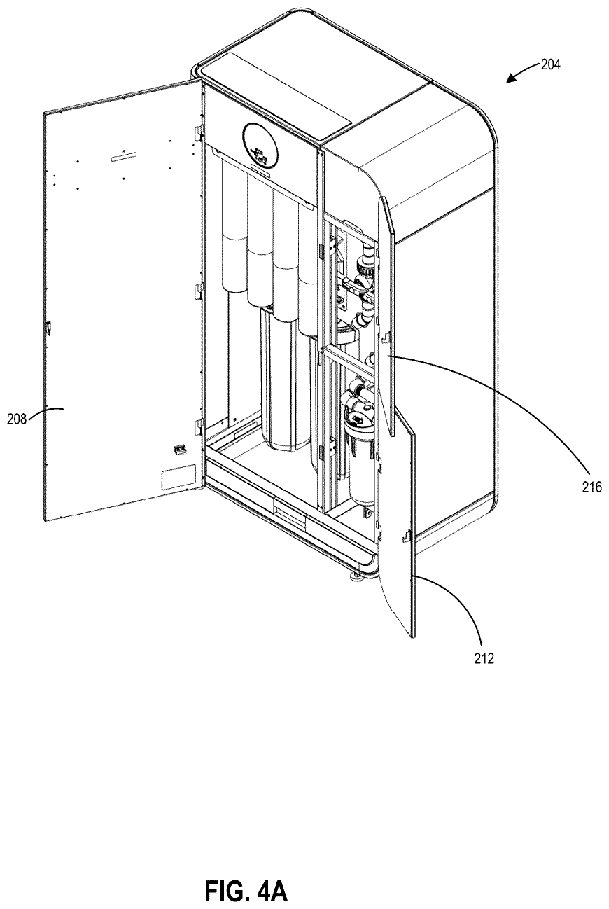

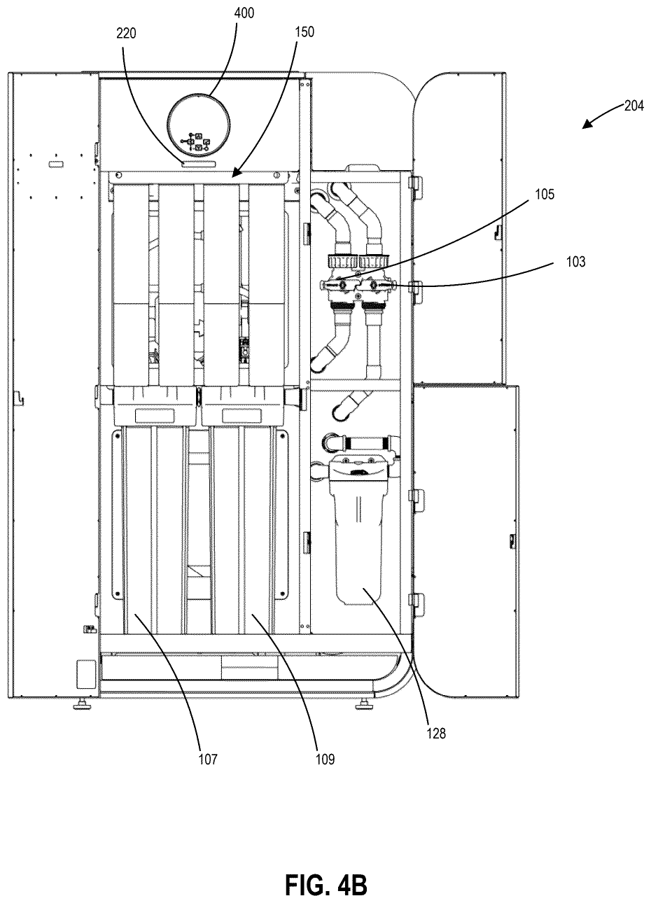

FIG. 4A is a perspective view of the processor enclosure 204 of FIG. 2 with doors opened. FIG. 4B is a front view of the processor enclosure 204 of FIG. 2 with doors opened. Referring to both FIG. 4A and FIG. 4B as well as FIG. 2, the processor enclosure 204 allows access to certain components of the water treatment system 100 when the first door 208, the second door 212, and/or the third door 216 are open. As shown, the mineralization cartridges 150, the sediment filter 107, the carbon filter 109, the antiscalant feeder 128, the inlet bypass valve 103, and the outlet bypass valve 105 are accessible from the front of the panel. The processor enclosure 204 may also house at least a portion of the control system 400. For example, the processor enclosure 204 may house the display 450. The status light 220 may also be visible if the first door 208 is open. Allowing access to these components may facilitate easier diagnosis, servicing, or routine maintenance of the water treatment system 100.

FIG. 5 is a schematic illustration of the control system 400 used with the water treatment systems of FIGS. 1A-B, 2, 3A-3C, and 4A-4D according to some embodiments. The controller 402 may be electronically connected to the display 450 and the water treatment system components including the various sensors, valves, feeder, and pump via one or more wires or may be electronically connected via a communications network. The communications network may be a wireless network such as a personal area network (PAN) or local area network (LAN), a cellular network, or the Internet. In some embodiments, the display 450 may be an LED, LCD, or OLED display.

The controller 402 may be Bluetooth enabled and have Internet of Things (IoT) connectivity. The water treatment system components (e.g., the sensors, valves, feeder, and/or pump) may be IoT-enabled and/or communicatively connected smart components. In some embodiments, the controller 402 may be configured to communicate using one or more wireless protocols. The wireless protocols may include Wi-Fi (e.g., an 802.11x network, which can include one or more wireless routers, one or more switches, etc.), peer-to-peer (e.g., a Bluetooth network, a ZigBee® network, a Z-Wave® network, a proprietary RF connection, etc.), or cellular (e.g., a 3G network, a 4G network, etc., complying with any suitable standard, such as CDMA, GSM, LTE, LTE Advanced, WiMAX, etc.).

The controller 402 may send or receive electronic signals from one or more of the sensors including the pressure sensors (e.g., 106a-106d), flowmeters (e.g., 114a-114c), TDS sensors (e.g., 116a-116f), and/or any other sensors provided in the water treatment system 100. The electronic signals received from one or more of the sensors may provide measurements and other data regarding pressure, flow rate, total dissolved solids, or conductivity of the water at various locations in the water treatment system 100. The measurements and other data may be sent to the controller 402 by the one or more sensors continuously, frequently or periodically.

The control system 400 may use the measurements or other data received from one or more of the sensors to send electronic signals to the valves, feeders, or the pumps. In some embodiments, the controller 402 may send an electronic signal to a first actuated valve 108, the second actuated valve 129, the third actuated valve 153, the fourth actuated valve 158, and/or the fifth actuated valve 160 to open or close, partially or fully. The controller 402 may send an electronic signal to the status light 220 to display a particular color (e.g., blue, yellow, or red). The controller 402 may send an electronic signal to the pump 130 to start, stop, increase, or decrease the speed of the pump. Adjusting one or more of the valves, the feeder, and/or the pump may change the flow rate of the water into, through or out of the system, the flow direction of the water within the system, and/or the pressure of the water in various lines of the water treatment system. The controller 402 may also receive electronic signals from the valves, feeders, and/or pumps.

The controller 402 may include electronic components such as one or more processors 404, a memory 406 (e.g., random access memory (RAM)), an input/out device 408, and a power supply 410 (e.g., battery or AC adapter plug). The controller 402 may be able to download, store, and/or execute software having computer executable instructions. The input/out device 408 can include one or more buttons, switches, touchscreen interfaces, and/or other human-machine interface elements. The software may include one or more modules. The one or more modules may include, for example, algorithms to monitor and/or store the measurements or other data received from one of more of the system components such as the sensors, valves, or pumps or may monitor and/or store real-time and historic flow patterns and usage data. The controller 402, via the one or more modules, may also perform calculations or other data analysis or modeling process to determine various outcomes. The outcomes may include, for example, turning one or more of the system components of the water treatment system on or off at certain times or intervals or placing one or more of the system components in standby mode.

In some embodiments, the controller 402 may be able to self-diagnose or troubleshoot problems that arise without input from a user.

For example, in some embodiments, if water usage is high during certain intervals of the day, the control system 400 may activate the water treatment system to enter certain phases of the operational cycle during low water usage times. For example, if water usage is high during the morning and/or afternoon, the controller 402 may activate the water treatment system to process high TDS water that may be stored in the tank 118 through the membrane element to produce more membrane permeate and/or the controller 402 may activate the water treatment system to perform a membrane permeate flush of the membrane element during the night when there is less demand on the system.

In addition, if the water treatment system is not being used regularly (e.g., the user is on vacation or is traveling frequently), then certain components of the system, for example, the membrane element, may be adversely affected due to stagnation. To combat stagnation, the controller 402 may activate certain operational cycles of the system (e.g., the membrane permeate flush) if the water treatment system is not used within a certain period of time (e.g., 24 hours, 48, hours, 72 hours, 96 hours, etc.).

In some embodiments, the controller 402 may be coupled to a secondary power supply 412. In some embodiments, the power supply 410 may be provide power at a first voltage to the controller 402 and the secondary power supply 412 may provide power at a second voltage to the controller 402. For example, the secondary power supply 412 may provide power at 24V DC and the power supply 410 may provide power at 5V DC. Certain components such as the controller 402 and the valves may require 24V DC, and other components such as certain sensors may require 5V DC.

In some embodiments, the controller 402 may be coupled to and in communication with a secondary device 414. The secondary device 414 may be a mobile phone, tablet computer, laptop computer, desktop computer, or another suitable computing device. The controller 402 may be able to communicate with the secondary device 414 using a wireless protocol such as Bluetooth. Bluetooth may be preferable where Wi-Fi or cellular reception is poor, such as certain basements. In some embodiments, the controller 402 may be configured to communicate with the secondary device 414 using one or more wireless protocols including Wi-Fi (e.g., an 802.11x network, which can include one or more wireless routers, one or more switches, etc.), peer-to-peer (e.g., a Bluetooth network, a ZigBee® network, a Z-Wave® network, a proprietary RF connection, etc.), or cellular (e.g., a 3G network, a 4G network, etc., complying with any suitable standard, such as CDMA, GSM, LTE, LTE Advanced, WiMAX, etc.).

FIG. 6 illustrates an operational cycle 501 according to some embodiments of the water treatment systems of FIG. 1A and FIG. 1B. At a high level, some embodiments of the water treatment systems disclosed herein may operate according to the operational cycle 501. The operational cycle 501 may include four phases: Phase I, Phase II, Phase III, and Phase IV.

Referring to FIG. 1A and FIG. 1B as well as FIG. 6, the operational cycle 501 may begin at a Phase I. In Phase I, consumption of water at a point of use (POU) (not shown) such as a facet, fixture, or toilet, may commence. When water consumption commences, a change in pressure in the line going from an outlet 548 (e.g., the outlet 148 and/or outlets 148a-n) of a water treatment system 500 to the POU may cause water to flow to the POU. The pressure change may also cause untreated inlet water to enter the water treatment system through an inlet 502 (e.g., the inlet 502). The untreated inlet water may flow into a prefiltration unit 510. The prefiltration unit may include the sediment filter 107 and the carbon filter 109. The prefiltration unit 510 may filter the untreated inlet water producing a prefiltered water. The prefiltered water may flow into a bottom portion of a tank 518 (e.g., the tank 118). The flowing of the prefiltered water (denser, higher TDS water) into the bottom portion of the tank 518 may cause membrane permeate (less dense, lower TDS water) at the top portion of the tank 518 to flow out of tank. The membrane permeate flowing out of the top of the tank 518 may flow through the outlet 548 of the water treatment system toward the POU.

As the membrane permeate from the top portion of the tank 518 begins to flow out toward the outlet 548, the amount of prefiltered water entering the tank may rise.

When the level of prefiltered water in the tank 518 reaches a certain threshold (e.g., reaches a certain volume within the bottom portion of the tank), the pump 530 (e.g., the pump 130) may be activated in Phase II. When the pump 530 is activated, untreated inlet water may flow into the prefiltration unit 510. The prefiltered water produced by the prefiltration unit 510 may flow toward the pump 530, rather than directly into the tank 518. The prefiltered water may then be directed toward a membrane element 534 either via pressure changes in the system or by the pump 530. The membrane element 134 can include the first membrane element 134 and the second membrane element 135. The membrane element 534 may remove solutes from the prefiltered water producing a membrane permeate (water with no solutes) that may exit the membrane element 534, and a retentate (water with solutes) that may be discharged from the water treatment system via a retentate line 536 (e.g., retentate line 136). If water consumption is high, then the membrane permeate may flow directly from the membrane element 534 out of the outlet 548 to the POU, thereby bypassing the tank 518.

Otherwise, if the amount of water being consumed is not high or has stopped, then membrane permeate may generally flow from the membrane element 534 into the tank 518 for later use as shown in Phase III. The membrane permeate may pass through the mineralization cartridges 150a-d to produce remineralized water that flows to the tank 118. In Phase III, once consumption of the water has ceased, the prefiltered water that had previously entered the bottom portion of the tank 518 directly from the prefiltration unit 510, may be processed by the membrane element 534. The prefiltered water may flow from the bottom portion of the tank 518 toward the pump 530 and through the membrane element 534 for processing. The remineralized water that may be produced from the processing of the prefiltered water from the tank 518, may flow into the top portion of the tank 518 for storage, and any retentate will be discharged from the water treatment system via the retentate line 536.

Once all the prefiltered water in the tank 518 has been processed (e.g., the tank is full or mostly full of membrane permeate), the water treatment system may then move to Phase IV in the operational cycle 501. In Phase IV, the stored remineralized water may be used to clean or flush the membrane element 534. The remineralized water stored in the tank 518 may flow out of the tank 518, toward the membrane element 534. The pump 530 may be activated to direct the remineralized water toward the membrane element 534 to clean the membrane element 534. In some embodiments, pressure in the various lines of the water treatment system may be sufficient to cause the remineralized water to flow out of the tank 518 and toward the membrane element 534 to clean the membrane element 534 with the pump 530 turned off. The remineralized water used to clean the membrane element 534 may be discharged from the water treatment system via the retentate line 536.

Once the membrane element 534 has been flushed, the water treatment system may go into a standby mode (not shown). In standby mode, none of the system components are activated. However, water may still flow through the system, between components, and/or out of the outlet 548 to a point of use. In some embodiments, water may not flow from the prefiltration unit 510 to the pump 530 or membrane element 534 when the system 500 is in standby mode. When consumption of water commences again, the operational cycle 501 will move to Phase I.

The standby mode may also be used when there is no electrical power to the water treatment system 100. If there is not power to run the pump 130, actuate valves, and/or receive data from sensors, the water treatment system 100 may still be able to provide prefiltered water to the outlet 148 and/or outlets 148a-n without any input from a user and/or the control system 400. Inlet pressure at the inlet 102 may be sufficient to cause inlet water to flow through the sediment filter 107 and the carbon filter 109 to generate prefiltered water. The prefiltered water can flow to the tank 118 where it can push out water near the top of the tank 118 towards the outlet. In this way, the water treatment system 100 can provide a continuous supply of prefiltered water even without electrical power. Additionally, any remineralized water that has previously been processed by the membranes 134, 135 that is stored near the top of the tank 118 will automatically be supplied to the outlet 148 and/or outlets 148a-n before any prefiltered water. In this way, the water treatment system 100 can potentially provide a limited supply of remineralized water if there is remineralized water in the tank 118 even if there is no power to the water treatment system 100. In some cases, the water treatment system 100 may provide up to the capacity of the tank 118 of remineralized water before continuously providing prefiltered water to the outlet 148 and/or outlets 148a-n.

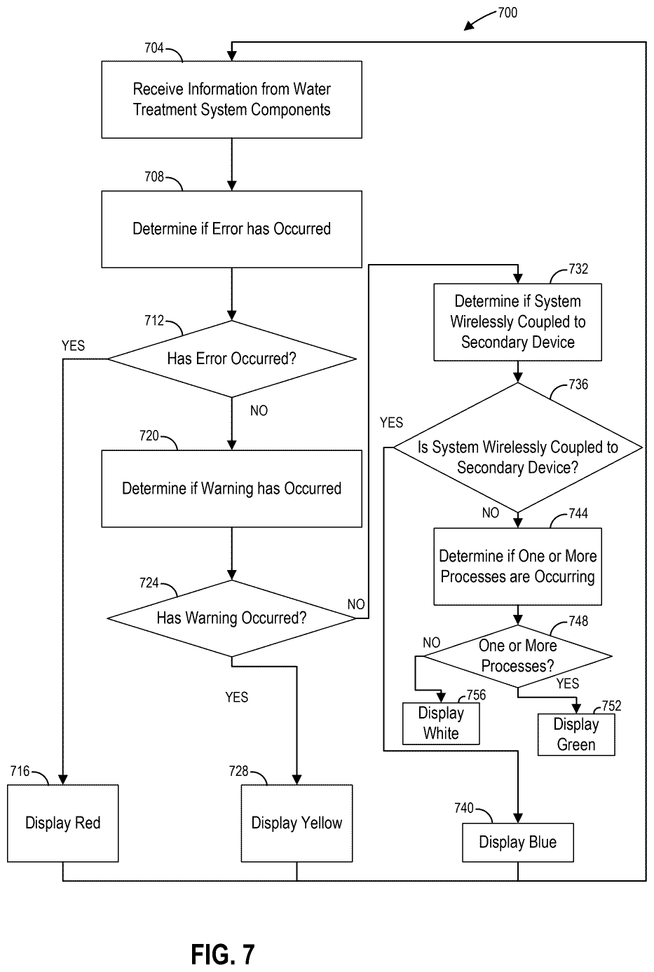

FIG. 7 is a flow diagram for a method 700 for controlling the warning light 220 in FIG. 2. The method 700 may be implemented as computer-readable instructions and implemented in the control system 400.

At 704, the method 700 may receive information from one or more water treatment system components. The method 700 may receive information from one or more sensors included in the pressure sensors (e.g., 106a-106d), flowmeters (e.g., 114a-114c), and/or TDS sensors (e.g., 116a-116f) included in the water treatment system 100 in FIG. 1A and/or the water treatment system 190 in FIG. 1B. The method 700 may receive pressure values, flow rate values, and/or TDS values. The method 700 may receive information from one or more valves included in the first, second, third, fourth, and/or fifth actuated valves (108, 129, 153, 158, and 160, respectively) and/or the pump 130. In some embodiments, the method 700 may receive information that a command was not carried out by a valve and/or the pump 130. For example, the method 700 may receive information that a valve is unable to position itself according to a command (e.g., to open or to close). As another example, the method 700 may receive information that the pump is not functioning as commanded. The method 700 may receive no feedback from the sensors, the valve, and/or the pump 130, for example, if communications are interrupted. In some embodiments, the method 700 may collect and store the information as historical information. In some embodiments, the method 700 may receive connectivity information from one or more water treatment system components (e.g., the controller 402). The connectivity information can include an indication of if the secondary device 414 is in communication (e.g., wireless communication) with the water treatment system 100. In some embodiments, the method 700 may receive water process information about how many water processes are being executed by the water treatment system 100. In some embodiments, the water processes can include generating permeate using the membranes 134, 135, flushing the membranes 134, 135, and/or performing a depressurization process.

At 708, the method 700 may determine if an error has occurred. In some embodiments, the method 700 may determine that an error has occurred if the pump is offline (e.g., no signal from the pump). In some embodiments, the method 700 may determine that an error has occurred if a valve is malfunctioning (e.g., the valve cannot fully open or close). In some embodiments, the method 700 may compare values from the sensors to one or more predetermined acceptable ranges of values and determine that a pressure value, a flow rate value, and/or a TDS value are outside of an acceptable range of values, and that an error has occurred. In some embodiments, the method 700 may determine if one or more components (e.g., filters) need to be replaced immediately based on historical data, and determine that an error has occurred.

At 712, if the method 700 has determined that an error has occurred (i.e., “YES” at 712), the method 700 may proceed to 716. Otherwise, the method 700 may proceed to 720.

At 716, the method 700 may cause the light indicator 220 to display a red color.

At 720, the method 700 may determine if a warning has occurred. In some embodiments, the method 700 may compare values from the sensors to predetermined threshold values and/or acceptable range of values and determine that a pressure value, a flow rate value, and/or a TDS value are outside of a preferable range of values, and that a warning has occurred. The preferable ranges may be narrower than the acceptable ranges of values, indicating that the system 100 can keep operating for the near future, but that an error may potentially occur if the warning is not addressed. In some embodiments, the method 700 may determine if one or more components (e.g., filters) need to be replaced soon (e.g., within a month) based on historical data, and determine that an warning has occurred.

At 724, if the method 700 has determined that a warning has occurred (i.e., “YES” at 724), the method 700 may proceed to 728. Otherwise, if no errors or warnings have occurred, the method 700 may proceed to 732.

At 728, the method 700 may cause the light indicator 220 to display a yellow color.

At 732, the method 700 may determine if the water treatment system 100 and/or the water treatment system 190 is in communication with the secondary device 414 based on the connectivity information.

At 736, if the method 700 has determined that the water treatment system 100 and/or the water treatment system 190 is in communication with the secondary device 414 (i.e., “YES” at 736), the method 700 may proceed to 740. Otherwise, the method can proceed to 744.

At 740, the method 700 may cause the light indicator 220 to display a blue color.

At 744, the method 700 may determine if one or more water processes are occurring based on the water process information.

At 748, if the method 700 has determined that or more water processes are occurring (i.e., “YES” at 748), the method 700 may proceed to 752. Otherwise, the method can proceed to 756.

At 752, the method 700 may cause the light indicator 220 to display a green color.

At 756, the method 700 may cause the light indicator 220 to display a white color.

The method 700 may provide an easily understandable system diagnosis to a user (e.g., a homeowner, a technician, etc.).

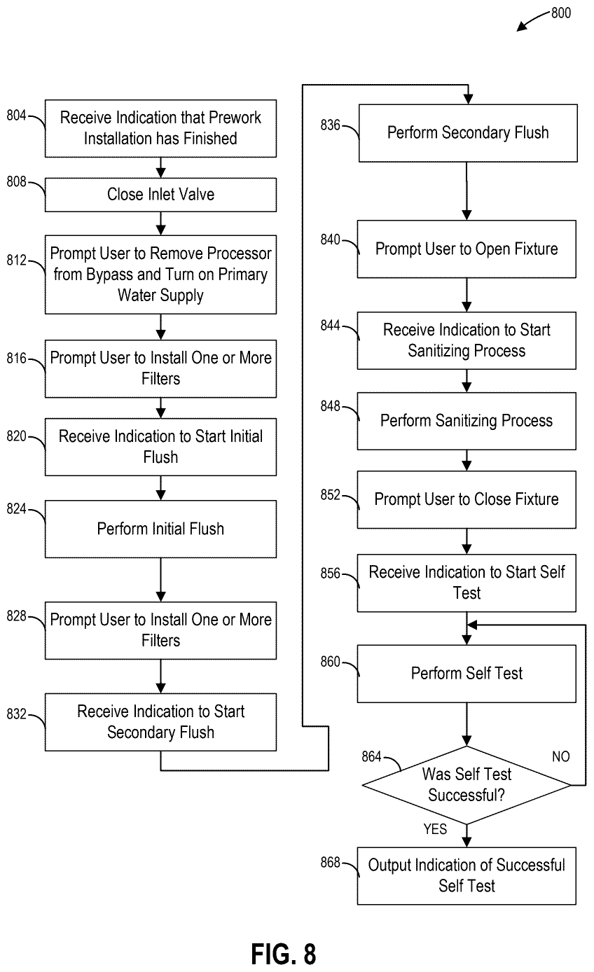

FIG. 8 is a flow diagram for a method 800 for guiding a user through installation of the water treatment system 100 in FIG. 1A and/or the water treatment system 190 in FIG. 1B. The method 800 may be implemented as computer-readable instructions and implemented in the control system 400.

At 804, the method 800 may receive an indication that prework installation has finished. A user (e.g., a technician installing the water treatment system 100) may provide the indication at the input/output device 408. The user may provide the indication after completing prework including turning off a primary water supply (e.g., a home water supply), placing the bypass valves 103, 105 in bypass configuration, plumbing primary inlet and outlet valves (e.g., home inlet and outlet valves) to the inlet 102 and the outlet 148, adding sanitizer powder to the an inlet of the tank 118, plumbing the tank 118 to the processing subsystem 101 via the prefiltered water line 112 and the tank line 144, plumbing the drain 141 to a primary drain line (e.g., a home drain line), placing the tank 118 on bypass, and providing power to and turning on the water treatment system 100. When installing the water treatment system 190 in FIG. 1B, the user may additionally provide an indication that the outlets 148a-n, 171, 174, and/or 177 have been plumbed to appropriate valves and/or manifolds. When installing the water treatment system 190, the technician and/or the method 800 may close outlet valves 172, 175, and 178, and open outlet valves 164a-n.

At 808, the method 800 may close the first actuated valve 108.

At 812, the method 800 may prompt the user to place the bypass valves 103, 105 in the normal configuration and then turn on the primary inlet valve to supply water to the input 102. The method may prompt the user at the input/output device 408 and/or the display 450.

At 816, the method 800 may prompt the user to install one or more filters. The method may prompt the user at the input/output device 408 and/or the display 450. The method 800 may prompt the user to install the sediment filter 107, the carbon filter 109, and the antiscalant feeder 128.

At 820, the method 800 may receive an indication to start an initial flush. The method may receive the indication from the input/output device 408 and/or the display 450. The method 800 may prompt the user to provide the indication after the installation of the filters.

At 824, the method 800 may cause an initial flush to be performed. The initial flush may include opening the first actuated valve 108, opening the fifth actuated valve 160, waiting five minutes, closing the fifth actuated valve 160, and closing the first actuated valve 108. In some embodiments, the method 800 may determine that inlet pressure is not sufficient based on information from a pressure sensor (e.g., the first pressure sensor 106a) and prompt the user to check that the inlet 102 was properly coupled to the primary inlet valve.

At 828, the method 800 may prompt the user to install one or more filters. The method may prompt the user at the input/output device 408 and/or the display 450. The method 800 may prompt the user to install the first membrane element 134, the second membrane element 135, and the mineralization cartridges 150a-d. The method 800 may also prompt the user to cut a reject tube to length and install the reject tube as the flow restrictor 143.

At 832, the method 800 may receive an indication to start a secondary flush. The method may receive the indication from the input/output device 408 and/or the display 450. The method 800 may prompt the user to provide the indication after the installation of the filters at 828.

At 836, the method 800 may cause a secondary flush to be performed. The secondary flush may include opening the first actuated valve 108, moving the filtration valve to position 2, turning on the pump 130, opening the fourth actuated valve 158, waiting fifteen minutes, turning off the pump, closing the fourth actuated valve 158, moving the filtration valve to position 1, and closing the first actuated valve 108.

At 840, the method 800 may prompt the user to open a fixture fluidly coupled to the outlet 148 and/or outlets 148a-n. The method 800 may also prompt the user to remove the tank from bypass. The method may prompt the user at the input/output device 408 and/or the display 450.

At 844, the method 800 may receive an indication to start a sanitizing process. The method may receive the indication from the input/output device 408 and/or the display 450.

At 848, the method 800 may cause a sanitizing process to be performed. The sanitizing process may include opening the first actuated valve 108, determining that the sixth TDS sensor 114f is detecting water, determining that the third flow meter 114c is detecting a flow rate of at least one gallon per minute (four liters per minute), closing the first actuated valve 108, waiting fifteen minutes, opening the first actuated valve 108, determining that a volume of water equal to the capacity of the tank has flowed to the outlet 148 and/or outlets 148a-n, and closing the first actuated valve 108.

At 852, the method 800 may prompt the user to close the fixture fluidly coupled to the outlet 148 and/or outlets 148a-n. The method 800 may prompt the user at the input/output device 408 and/or the display 450.

At 856, the method 800 may receive an indication to start a self test. The method may receive the indication from the input/output device 408 and/or the display 450.

At 860, the method 800 may perform a self test. The self test may include opening the first actuated valve 108, moving the filtration valve to position 2, turning on the pump 130, determining that determining that a volume of water equal to the capacity of the tank has flowed to the outlet 148 and/or outlets 148a-n, turning off the pump 130, and moving the filtration valve to position 1.

At 864, the method 800 may determine if the self test was successful. In some embodiments, the method 800 may receive data from each sensor included in the water treatment system 100, compare the data to predetermined bound values for each sensor, and determine that the self test was successful if the data from each of the sensors is within the corresponding predetermined bounds. Otherwise, the method 800 may determine that the self test was not successful. If the self test was successful, the method can proceed to 868. Otherwise, the method 800 may proceed to 860.

At 868, the method 800 may output an indication of a successful self test at the input/output device 408 and/or the display 450.

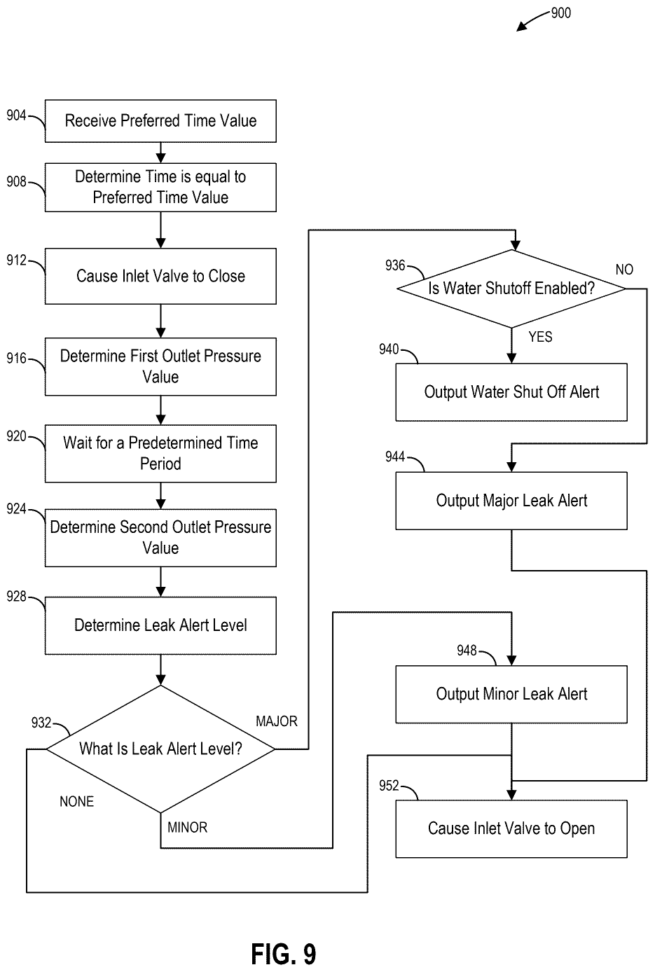

FIG. 9 is a flow diagram for a method 900 for determining leaks. The method 900 can be implemented in the water treatment system 190 shown in FIG. 1B. The method 900 may be implemented as computer-readable instructions and implemented in the control system 400. In some embodiments, the method 900 can be used in water treatment systems with a single outlet (e.g., the outlet 148 in FIG. 1A or the first outlet 148a in FIG. 1B). In some embodiments, the method 900 can be used in water treatment systems with multiple outlets (e.g., the first outlet 148a and the second outlet 148b in FIG. 1B).

At 904, the method 900 can receive a preferred time value. In some embodiments, a user can provide the preferred time value at a user interface. The preferred time value can be associated with a preferred time at which the user prefers to run a leak detection method. The method 900 may also receive a water shutoff enable value at 904. The water shutoff enable value can be represented as a Boolean value, with “true” indicating that water shutoff is enabled and “false” indicating that water shutoff is not enabled. In some embodiments, the water shutoff enable value can be preset to “false.”

At 908, the method 900 can determine that the current time is equal to the preferred time value.

At 912, the method 900 can cause an inlet valve to close. The inlet valve can be the first actuated valve 108.

At 916, the method 900 can determine a first outlet pressure value. In some embodiments, the method 900 can receive the first outlet pressure value from a sensor positioned near the outlet(s) of the water treatment system. In some embodiments, the sensor can be the fourth pressure sensor 106d.

At 920, the method 900 can wait for a predetermined time period. In some embodiments, the predetermined time period can be about one minute. In some embodiments, the predetermined time period can be about 30 seconds to five minutes.

At 924, the method 900 can determine a second outlet pressure value. In some embodiments, the method 900 can receive the second outlet pressure value from a sensor positioned near the outlet(s) of the water treatment system. In some embodiments, the sensor can be the fourth pressure sensor 106d.

At 928, the method 900 can determine a leak alert level based on the first outlet pressure value and the second outlet pressure value. In some embodiments, the leak alert level can be selected from a predetermined set of leak alert levels. In some embodiments, the set of leak alert levels can include a major alert, a minor alert, and no alert. In some aspects, the method 900 can determine the leak alert level based on a first pressure drop threshold and a second pressure drop threshold.

The method 900 can determine whether or not a pressure dropped by the first pressure drop threshold value. The method 900 can calculate the difference of the subtraction of the second outlet pressure value from the first outlet pressure value. In some embodiments, the first pressure drop threshold value can be about 1 PSI to 5 PSI (0.07 bar to 0.34 bar). In a preferred embodiment, the first pressure drop threshold value can be about 3 PSI (0.21 bar).

If the difference is more than the first pressure drop threshold value, the method 900 can determine that the pressure has dropped by the first pressure drop threshold value. For example, if the first outlet pressure value is 40 PSI (2.76 bar), the second outlet pressure value is 35 PSI (2.41 bar), and the first pressure drop threshold value is 3 PSI (0.21 bar), the method 900 can determine that the pressure has dropped by the first pressure drop threshold value.

If the difference is not than the first pressure drop threshold value, the method 900 can determine that the pressure has not dropped by the first pressure drop threshold value. For example, if the first outlet pressure value is 40 PSI (2.76 bar), the second outlet pressure value is 38 PSI (2.62 bar), and the first pressure drop threshold value is 3 PSI (0.21 bar), the method 900 can determine that the pressure has not dropped by the first pressure drop threshold value.

If the method 900 determines that the difference is not than the first pressure drop threshold value, the method can determine whether or not the difference is more than the second pressure drop threshold. The second pressure drop threshold can be less than the first pressure drop threshold.

The method 900 can calculate the difference of the subtraction of the second outlet pressure value from the first outlet pressure value. In some embodiments, the second pressure drop threshold value can be about 0.5 PSI to 2 PSI (0.03 bar to 0.14 bar). In a preferred embodiment, the second pressure drop threshold value can be about 1 PSI (0.07 bar).

If the difference is more than the second pressure drop threshold value, the method 900 can determine that the pressure has dropped by the second pressure drop threshold value. For example, if the first outlet pressure value is 40 PSI (2.76 bar), the second outlet pressure value is 38 PSI (2.62 bar), and the second pressure drop threshold value is 1 PSI (0.07 bar), the method 900 can determine that the pressure has dropped by the second pressure drop threshold value.

If the difference is not than the second pressure drop threshold value, the method 900 can determine that the pressure has not dropped by the second pressure drop threshold value. For example, if the first outlet pressure value is 40 PSI (2.76 bar), the second outlet pressure value is 39.5 PSI (2.72 bar), and the second pressure drop threshold value is 1 PSI (0.07 bar), the method 900 can determine that the pressure has not dropped by the second pressure drop threshold value.

If the method 900 determines that the pressure has dropped by the first pressure drop threshold value, the method 900 can determine that the leak alert level is a major leak alert level. If the method 900 determines that the pressure has not dropped by the first pressure drop threshold value but has dropped by the second pressure drop threshold value, the method 900 can determine that the leak alert level is a minor leak alert level. If the method 900 determines that the pressure has not dropped by either the first pressure drop threshold value or the second pressure drop threshold value, the method 900 can determine that the leak alert level is a no alert level.

If the method 900 determines that the leak alert level is a major leak alert level (i.e., “MAJOR” at 932), the method 900 can proceed to 936. If the method 900 determines that the leak alert level is a minor leak alert level (i.e., “MINOR” at 932), the method 900 can proceed to 948. If the method 900 determines that the leak alert level is a no alert level (i.e., “NONE” at 932), the method 900 can proceed to 952.

At 936, the method 900 can determine if water shutoff is enabled. In some embodiments, the method 900 can determine that the water shutoff is enabled if the water shutoff enable value is “true.” In some embodiments, the method can determine that the water shutoff is not enabled if the water shutoff enable value is “false.” If the method 900 determines that the water shutoff is enabled (i.e., “YES” at 936), the method 900 can proceed to 940. If the method 900 determines that the water shutoff is not enabled (i.e., “NO” at 936), the method 900 can proceed to 944.

At 940, the method 900 can output a water shut off alert. The water shut off alert can indicate that the inlet valve is closed and will remain closed until the user indicates that the inlet valve can be opened again.

At 944, the method 900 can output a major leak alert. The major leak can indicate that a major leak has been detected and that the user may want to shut off water flowing into the water treatment system 190. In some embodiments, the major leak alert can contain and/or indicate information from one or more sensors included in the water treatment system such as flow rate data associated with the leak, a duration of the leak, a time that leak was detected (e.g., a time the major leak alert level was determined), and/or other data associated with the detected leak. In some embodiments, the method 900 can generate the major leak alert and output the major leak alert at one or more user interfaces. In some embodiments the method 900 can output the major leak alert at the display 450. In some embodiments the method 900 can cause the major leak alert to be displayed at a user interface of user device (e.g., the screen of a cellular phone, computing device, etc.). The method 900 can then proceed to 952.

At 948, the method 900 can output a minor leak alert. The minor leak can indicate that a major leak has been detected and that the user may want to investigate a small leak such as a faucet not being turned off all the way. In some embodiments, the minor leak alert can contain and/or indicate information from one or more sensors included in the water treatment system such as flow rate data associated with the leak, a duration of the leak, a time that leak was detected (e.g., a time the minor leak alert level was determined), and/or other data associated with the detected leak. In some embodiments, the method 900 can generate the minor leak alert and output the minor leak alert at one or more user interfaces. In some embodiments the method 900 can output the minor leak alert at the display 450. In some embodiments the method 900 can cause the minor leak alert to be displayed at a user interface of user device (e.g., the screen of a cellular phone, computing device, etc.). The method 900 can then proceed to 952.

At 952, the method 900 can cause the inlet valve to open. In this way, the water treatment system 190 can resume regular operation.

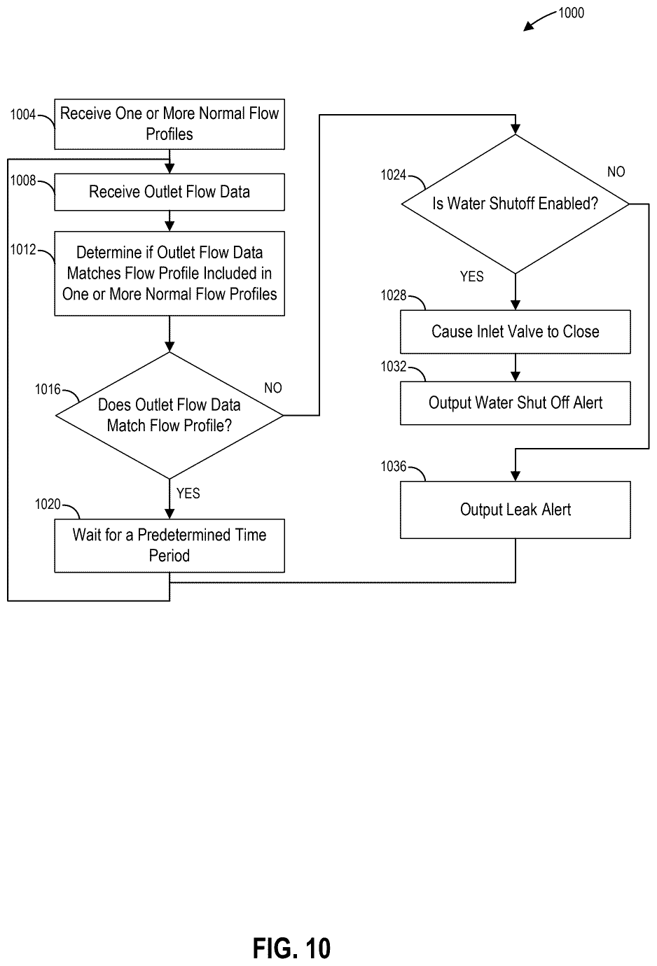

FIG. 10 is a flow diagram for another method 1000 for determining leaks. The method 1000 can be implemented in the water treatment system 190 shown in FIG. 1B. The method 1000 may be implemented as computer-readable instructions and implemented in the control system 400. In some embodiments, the method 1000 can be used in water treatment systems with a single outlet (e.g., the outlet 148 in FIG. 1A or the first outlet 148a in FIG. 1B). In some embodiments, the method 1000 can be used in water treatment systems with multiple outlets (e.g., the first outlet 148a and the second outlet 148b in FIG. 1B).

At 1004, the method 1000 can receive one or more normal flow profiles. In some embodiments, a user can provide the one or more normal flow profiles at a user interface. Each normal flow profile included in the one or more normal flow profiles can be associated with water actions being taken by fixtures fluidly coupled to the output(s) of the water treatment system. In some embodiments, the one or more normal flow profiles can include a toilet flush profile, a shower profile, a faucet profile, a plant watering profile, and/or combinations of profiles. In some embodiments, there can be multiple profiles associated with certain fixtures. For example, there can be multiple profiles associated with a shower such as a short shower profile, a medium shower profile, and a long shower profile. In some embodiments, there may be a toilet flush profile associated with a standard toilet and another toilet flush profile associated with a low flush toilet. The method 1000 may also receive a water shutoff enable value at 1004. The water shutoff enable value can be represented as a Boolean value, with “true” indicating that water shutoff is enabled and “false” indicating that water shutoff is not enabled. In some embodiments, the water shutoff enable value can be preset to “false.”

At 1008, the method 1000 can receive outlet flow data. In some embodiments, the method 1000 can receive outlet flow data from the third flow meter 114c. The outlet flow data can be indicative of a flow rate over time of the water being supplied at the outlet(s) of the water treatment system.

At 1012, the method 1000 can determine if the outlet flow data matches one or more flow profiles included in the one or more normal flow profiles. The method 1000 can determine if the flow outlet flow data is within predetermined bounds of each of the normal flow profiles. For example, one normal flow profile associated with a toilet flush may include water flowing at 3 gallons per minute (eleven liters per minute) for a duration of 15 seconds. If the outlet flow data includes water flowing at 3 gallons per minute (eleven liters per minute) for a duration of 15 seconds, the method 1000 can determine that the outlet flow data matches one or more flow profiles included in the one or more normal flow profiles. If the flow data includes water flowing at 3 gallons per minute (eleven liters per minute) for a duration of 30 seconds, the method 1000 can determine that the outlet flow data does not match the normal flow profile associated with a toilet flush. The method 1000 can compare the outlet flow data to each of the one or more normal flow profiles. If the method 1000 determines that none of the normal flow profiles match the outlet flow data, then the method 1000 can determine that that the outlet flow data does not match one or more flow profiles included in the one or more normal flow profiles.

At 1016, if the method 1000 determined that the outlet flow data does not match one or more flow profiles included in the one or more normal flow profiles (i.e., “NO” at 1016), the method 1000 can proceed to 1024. If the method 1000 determined that the outlet flow data does match one or more flow profiles included in the one or more normal flow profiles (i.e., “YES” at 1016), the method 1000 can proceed to 1020.

At 1020, the method 1000 can wait for a predetermined time period. In some embodiments, the predetermined time period can be about one minute. In some embodiments, the predetermined time period can be about 30 seconds to five minutes.

At 1024, the method 1000 can determine if water shutoff is enabled. In some embodiments, the method can determine that the water shutoff is enabled if the water shutoff enable value is “true.” In some embodiments, the method can determine that the water shutoff is not enabled if the water shutoff enable value is “false.” If the method 1000 determines that the water shutoff is enabled (i.e., “YES” at 1024), the method 1000 can proceed to 1028. If the method 1000 determines that the water shutoff is not enabled (i.e., “NO” at 1024), the method 1000 can proceed to 1036.

At 1028, the method 1000 can cause an inlet valve to close. The inlet valve can be the first actuated valve 108.

At 1032, the method 1000 can output a water shut off alert. The water shut off alert can indicate that the inlet valve is closed and will remain closed until the user indicates that the inlet valve can be opened again.

At 1036, the method 1000 can output a leak alert. The leak can indicate that a leak has been detected and that the user may want to investigate a small leak such as a faucet not being turned off all the way or a toilet refilling without stopping. In some embodiments, the leak alert can contain and/or indicate information from one or more sensors included in the water treatment system such as flow rate data associated with the leak, a duration of the leak, a time that leak was detected (e.g., a time that the method 1000 determined that the outlet flow data does not match one or more flow profiles included in the one or more normal flow profiles), and/or other data associated with the detected leak. In some embodiments, the method 1000 can generate the leak alert and output the leak alert at one or more user interfaces. In some embodiments the method 1000 can output the leak alert at the display 450. In some embodiments the method 1000 can cause the leak alert to be displayed at a user interface of user device (e.g., the screen of a cellular phone, computing device, etc.). The method 1000 can then proceed to 1008.

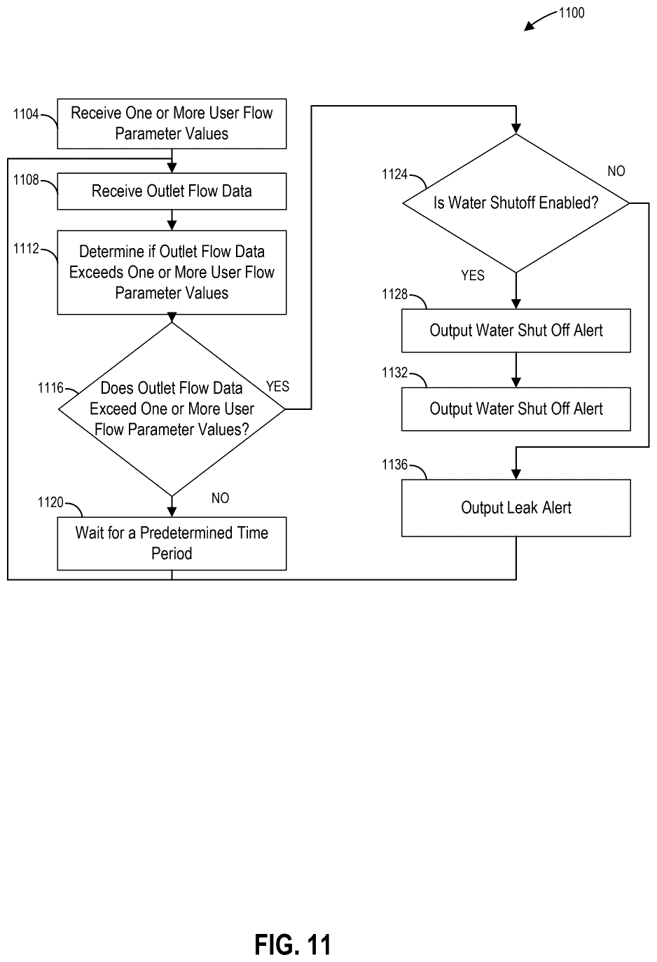

FIG. 11 is a flow diagram for yet another method 1100 for determining leaks. The method 1100 can be implemented in the water treatment system 190 shown in FIG. 1B. The method 1100 may be implemented as computer-readable instructions and implemented in the control system 400. In some embodiments, the method 1100 can be used in water treatment systems with a single outlet (e.g., the outlet 148 in FIG. 1A or the first outlet 148a in FIG. 1B). In some embodiments, the method 1100 can be used in water treatment systems with multiple outlets (e.g., the first outlet 148a and the second outlet 148b in FIG. 1B).

At 1104, the method 1100 can receive one or more user flow parameter values. In some embodiments, a user can provide the one or more user flow parameter values at a user interface. The one or more flow parameters values can be associated with an amount of water that has flowed from the water treatment system in a specified time period. In some embodiments, the one or more user flow parameter values can include a flow rate value and a time duration value.

At 1108, the method 1100 can receive outlet flow data. In some embodiments, the method 1100 can receive outlet flow data from the third flow meter 114c. The outlet flow data can be indicative of a flow rate over time of the water being supplied at the outlet(s) of the water treatment system.

At 1112, the method 1100 can determine if the outlet flow data exceeds the user flow parameter values. In some embodiments, the method can determine if each of the outlet flow data exceeds the flow rate value for more than the time duration value included in the one or more flow parameter values. If both outlet flow data exceeds each of the flow rate value and the time duration value, the method 1100 can determine that the outlet flow data exceeds the user flow parameter values. If the outlet flow data does not exceed one or both of the flow rate value and the time duration value, the method 1100 can determine that the outlet flow data does not exceed the user flow parameter values.

At 1116, if the method 1100 has determined that the outlet flow data exceeds the user flow parameter values (i.e., “YES” at 1116), the method 1100 can proceed to 1124. If the method 1100 has determined that the outlet flow data does not exceed the user flow parameter values (i.e., “NO” at 1116), the method 1100 can proceed to 1120.

At 1120, the method 1100 can wait for a predetermined time period. In some embodiments, the predetermined time period can be about one minute. In some embodiments, the predetermined time period can be about 30 seconds to five minutes.

At 1124, the method 1100 can determine if water shutoff is enabled. In some embodiments, the method can determine that the water shutoff is enabled if the water shutoff enable value is “true.” In some embodiments, the method 1100 can determine that the water shutoff is not enabled if the water shutoff enable value is “false.” If the method 1100 determines that the water shutoff is enabled (i.e., “YES” at 1124), the method 1100 can proceed to 1128. If the method 1100 determines that the water shutoff is not enabled (i.e., “NO” at 1124), the method 1100 can proceed to 1136.

At 1128, the method 1100 can cause an inlet valve to close. The inlet valve can be the first actuated valve 108.

At 1132, the method 1100 can output a water shut off alert. The water shut off alert can indicate that the inlet valve is closed and will remain closed until the user indicates that the inlet valve can be opened again.

At 1136, the method 1100 can output a leak alert. The leak can indicate that a leak has been detected and that the user may want to investigate a small leak such as a faucet not being turned off all the way or a toilet refilling without stopping. In some embodiments, the leak alert can contain and/or indicate information from one or more sensors included in the water treatment system such as flow rate data associated with the leak, a duration of the leak, a time that leak was detected (e.g., a time that the method 1100 determined that outlet flow data exceeds the user flow parameter values), and/or other data associated with the detected leak. In some embodiments, the method 1100 can generate the leak alert and output the leak alert at one or more user interfaces. In some embodiments the method 1100 can output the leak alert at the display 450. In some embodiments the method 1100 can cause the leak alert to be displayed at a user interface of user device (e.g., the screen of a cellular phone, computing device, etc.). The method 1100 can then proceed to 1108.

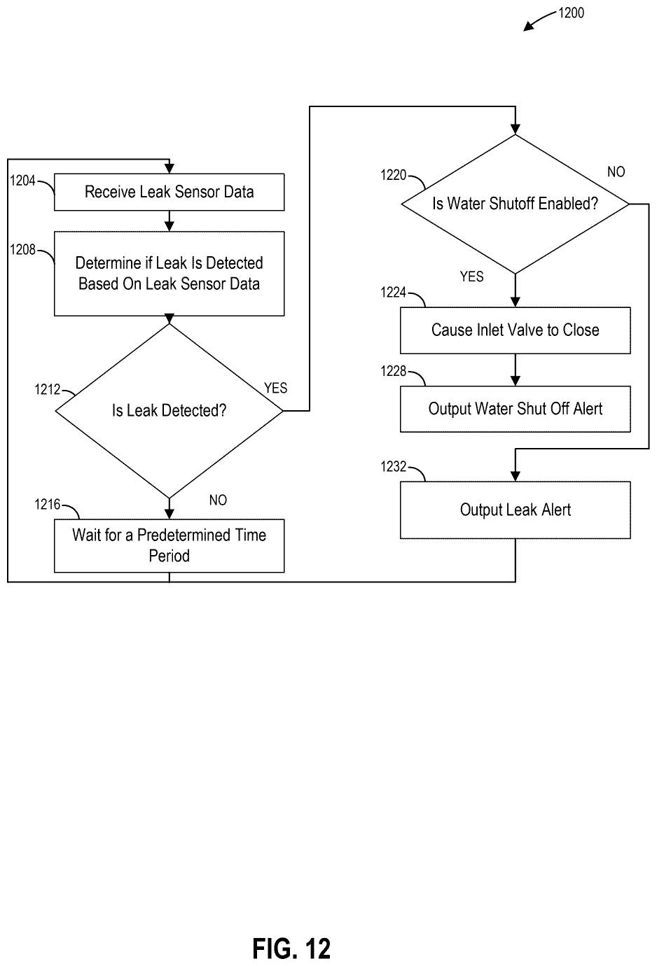

FIG. 12 is a flow diagram for a further method 1200 for determining leaks. The method 1200 can be implemented in the water treatment system 190 shown in FIG. 1B. The method 1200 may be implemented as computer-readable instructions and implemented in the control system 400. In some embodiments, the method 1200 can be used in water treatment systems with a single outlet (e.g., the outlet 148 in FIG. 1A or the first outlet 148a in FIG. 1B). In some embodiments, the method 1200 can be used in water treatment systems with multiple outlets (e.g., the first outlet 148a and the second outlet 148b in FIG. 1B).

At 1204, the method 1200 can receive leak sensor data from the leak detection sensor 180. The leak sensor data can be indicative of if there is moisture and/or a leak present in the water treatment system.

At 1208, the method 1200 can determine if a leak is detected based on the leak sensor data. In some embodiments, the method can determine that the leak detection data exceeds a predetermined leak threshold detection value.

At 1212, if the method 1200 has determined that a leak has been detected (i.e., “YES” at 1212), the method 1200 can proceed to 1220. If the method 1200 has determined that a leak has not been detected (i.e., “NO” at 1212), the method 1200 can proceed to 1216.

At 1216, the method 1200 can wait for a predetermined time period. In some embodiments, the predetermined time period can be about one minute. In some embodiments, the predetermined time period can be about 30 seconds to five minutes.

At 1220, the method 1200 can determine if water shutoff is enabled. In some embodiments, the method can determine that the water shutoff is enabled if the water shutoff enable value is “true.” In some embodiments, the method 1200 can determine that the water shutoff is not enabled if the water shutoff enable value is “false.” If the method 1200 determines that the water shutoff is enabled (i.e., “YES” at 1220), the method 1200 can proceed to 1224. If the method 1200 determines that the water shutoff is not enabled (i.e., “NO” at 1220), the method 1200 can proceed to 1232.

At 1224, the method 1200 can cause an inlet valve to close. The inlet valve can be the first actuated valve 108.

At 1228, the method 1200 can output a water shut off alert. The water shut off alert can indicate that the inlet valve is closed and will remain closed until the user indicates that the inlet valve can be opened again.

At 1232, the method 1200 can output a leak alert. The leak alert can indicate that a leak has been detected in the water treatment system. In some embodiments, the method 1200 can generate the leak alert and output the leak alert at one or more user interfaces. In some embodiments the method 1200 can output the leak alert at the display 450. In some embodiments the method 1200 can cause the leak alert to be displayed at a user interface of user device (e.g., the screen of a cellular phone, computing device, etc.). The method 1200 can then proceed to 1204.

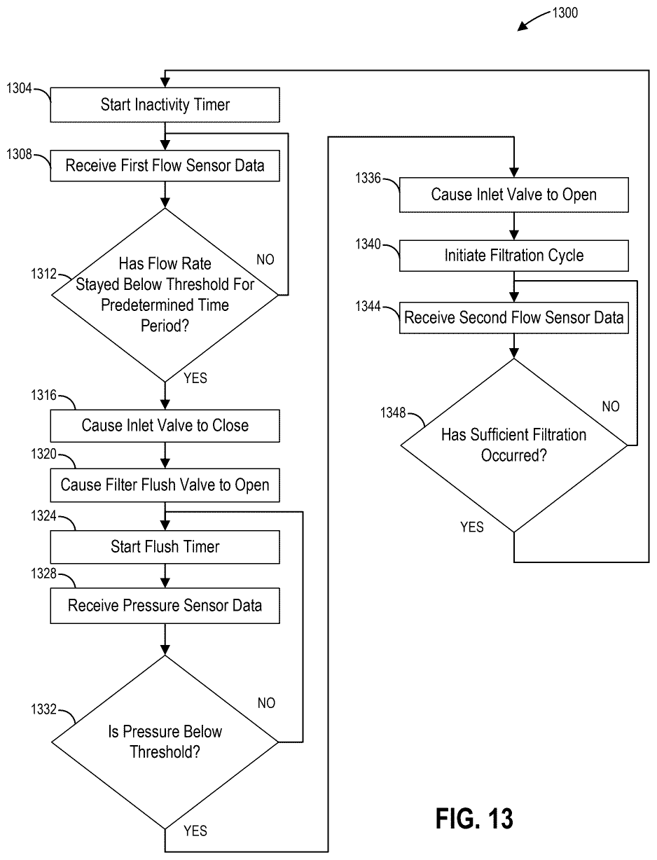

FIG. 13 is a flow diagram for a method 1300 for performing an inactivity flush. The method 1300 can be implemented in the water treatment system 190 shown in FIG. 1B. The method 1300 may be implemented as computer-readable instructions and implemented in the control system 400. In some embodiments, the method 1300 can be used in water treatment systems with a single outlet (e.g., the outlet 148 in FIG. 1A or the first outlet 148a in FIG. 1B). In some embodiments, the method 1300 can be used in water treatment systems with multiple outlets (e.g., the first outlet 148a and the second outlet 148b in FIG. 1B).

At 1304, the method 1300 can start an inactivity timer. The inactivity timer can update a time value indicative of how much time has passed since the method 1300 started the inactivity timer.

At 1308, the method 1300 can receive first flow sensor data from a first flow sensor. In some embodiments, the first flow sensor can be the third flowmeter 114c. The first flow sensor data can indicate a flow rate of fluid in a portion of the conduit in the water treatment system

At 1312, the method 1300 can determine if the flow rate at the first flow sensor has stayed below a predetermined flow threshold value for a predetermined time period threshold value. In some embodiments, the flow threshold value can be about 0.5 gallons per minute (about two liters per minute). In some embodiments, the time period threshold value can be about 48 hours. The method 1300 can compare the first flow sensor data received after the inactivity timer has been started to the flow threshold value to determine if the flow threshold value has been surpassed since the method 1300 started the inactivity timer. The method 1300 can also determine if the time value has surpassed the time period threshold value. If the time value has surpassed the time period threshold value and the first flow sensor data has not surpassed the flow threshold value, the method 1300 can determine that the flow rate has stayed below the predetermined flow threshold value for the predetermined time period threshold value. Otherwise, the method 1300 can determine that the flow rate has not stayed below the predetermined flow threshold value for the predetermined time period threshold value. In some embodiments, if the method 1300 determines that the flow rate has surpassed the predetermined flow threshold value, the method 1300 can restart the inactivity timer.

If the method 1300 determines that the flow rate has stayed below the predetermined flow threshold value for the predetermined time period threshold value (i.e., “YES” at 1312), the method 1300 can proceed to 1316. If the method 1300 determines that the flow rate has not stayed below the predetermined flow threshold value for the predetermined time period threshold value (i.e., “NO” at 1312), the method 1300 can proceed to 1308.

At 1316, the method 1300 can cause an inlet valve to close. The inlet valve can be the first actuated valve 108.

At 1320, the method 1300 can cause a filter flush valve to open. In some embodiments, the filter flush valve can be the fifth actuated valve 160.

At 1324, the method 1300 can start a flush timer. The flush timer can update a flush time value indicative of how much time has passed since the method 1300 started the flush timer.

At 1328, the method 1300 can receive pressure sensor data from a pressure sensor. In some embodiments, the pressure sensor can be the fourth pressure sensor 106d. The method 1300 can wait until the flush timer has reached a predetermined flush timer threshold value and then receive pressure sensor data from the pressure sensor. In some embodiments, the predetermined flush timer threshold value can be about 5 minutes.

At 1332, the method 1300 can determine if the pressure sensor data is less than a predetermined pressure threshold value. In some embodiments, the predetermined pressure threshold value can be about 5 PSI (0.34 bar). If the method 1300 determines that the pressure sensor data is less than the predetermined pressure threshold value (i.e., “YES” at 1332), the method 1300 can proceed to 1336. If the method 1300 determines that the pressure sensor data is not less than the predetermined pressure threshold value (i.e., “NO” at 1332), the method 1300 can proceed to 1324.

At 1336, the method 1300 can cause the inlet valve to open. In some embodiments, the method 1300 can cause the filter flush valve to close at 1336.

At 1340, the method 1300 can initiate a filtration cycle.

At 1344, the method 1300 can receive second flow sensor data from a second flow sensor. In some embodiments, the second flow sensor can be the first flow sensor 114a.

At 1348, the method 1300 can determine if sufficient filtration had occurred. In some embodiments, the method 1300 can determine that sufficient filtration has occurred if the second flow sensor data indicates that more than 5 gallons (19 liters) of fluid has flowed past the second flow sensor after initiation of the filtration cycle. If the method determines that sufficient filtration has occurred (i.e., “YES” at 1348), the method 1300 can proceed to 1304. Otherwise, if the method determines that sufficient filtration has not occurred (i.e., “NO” at 1348), the method can proceed to 1344.

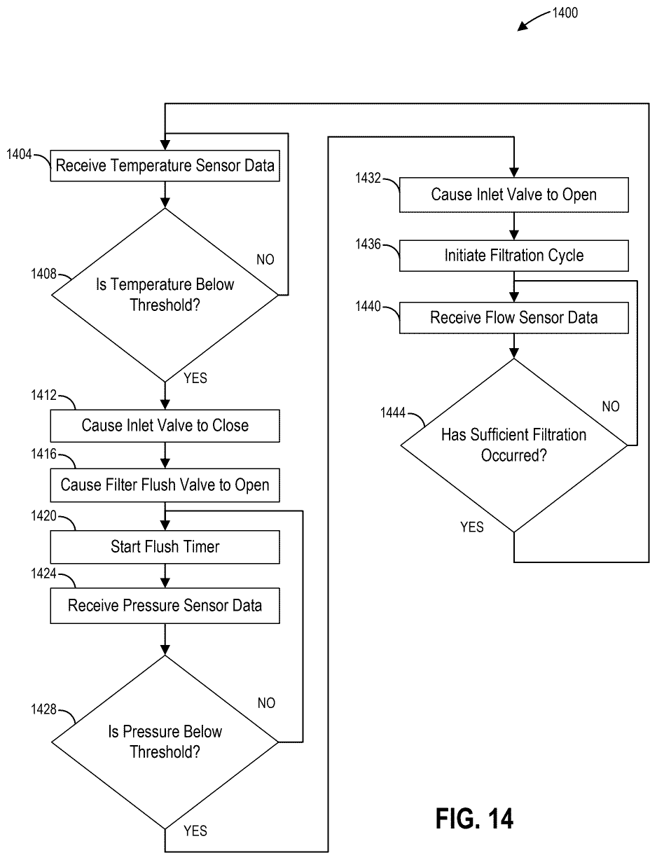

FIG. 14 is a flow diagram for a method 1400 for performing a freeze prevention cycle. The method 1400 can be implemented in the water treatment system 190 shown in FIG. 1B. The method 1400 may be implemented as computer-readable instructions and implemented in the control system 400. In some embodiments, the method 1400 can be used in water treatment systems with a single outlet (e.g., the outlet 148 in FIG. 1A or the first outlet 148a in FIG. 1B). In some embodiments, the method 1400 can be used in water treatment systems with multiple outlets (e.g., the first outlet 148a and the second outlet 148b in FIG. 1B).

At 1404, the method 1400 can receive temperature data from a temperature sensor. The temperature data can be indicative of a temperature of fluid in the water treatment system and/or in a specific location in the water treatment system. In some embodiments, the temperature sensor can be the temperature sensor 182 in FIG. 1B.

At 1408, the method 1400 can determine if the temperature data is indicative of a temperature below a predetermined temperature threshold value. In some embodiments, the predetermined temperature threshold values can be about 35 degrees Fahrenheit (1.7 degrees Celsius). The method 1400 can compare one or more temperature values included in the temperature data to the predetermined temperature threshold value and determine if one or more of the one or more temperature values is below the predetermined temperature threshold value. If the method 1400 determines that one or more of the one or more temperature values is below the predetermined temperature threshold value, the method 1400 can determine that the fluid temperature is below the predetermined temperature threshold value. Otherwise, the method 1400 can determine that the fluid temperature is not below the predetermined temperature threshold value.

If the method 1400 determines that the fluid temperature is below the predetermined temperature threshold value (i.e., “YES” at 1408), the method 1400 can proceed to 1412. If the method 1400 determines that the fluid temperature is not below the predetermined temperature threshold value (i.e., “NO” at 1408), the method 1400 can proceed to 1404.

At 1412, the method 1400 can cause an inlet valve to close. The inlet valve can be the first actuated valve 108.

At 1416, the method 1400 can cause a filter flush valve to open. In some embodiments, the filter flush valve can be the fifth actuated valve 160.

At 1420, the method 1400 can start a flush timer. The flush timer can update a flush time value indicative of how much time has passed since the method 1400 started the flush timer.

At 1424, the method 1400 can receive pressure sensor data from a pressure sensor. In some embodiments, the pressure sensor can be the fourth pressure sensor 106d. The method 1400 can wait until the flush timer has reached a predetermined flush timer threshold value and then receive pressure sensor data from the pressure sensor. In some embodiments, the predetermined flush timer threshold value can be about 5 minutes.

At 1428, the method 1400 can determine if the pressure sensor data is less than a predetermined pressure threshold value. In some embodiments, the predetermined pressure threshold value can be about 5 PSI (0.34 bar). If the method 1400 determines that the pressure sensor data is less than the predetermined pressure threshold value (i.e., “YES” at 1428), the method 1400 can proceed to 1432. If the method 1400 determines that the pressure sensor data is not less than the predetermined pressure threshold value (i.e., “NO” at 1428), the method 1400 can proceed to 1420.

At 1432, the method 1400 can cause the inlet valve to open. In some embodiments, the method 1400 can cause the filter flush valve to close at 1432.

At 1436, the method 1400 can initiate a filtration cycle.

At 1440, the method 1400 can receive second flow sensor data from a second flow sensor. In some embodiments, the second flow sensor can be the first flow sensor 114a.

At 1444, the method 1400 can determine if sufficient filtration had occurred. In some embodiments, the method 1400 can determine that sufficient filtration has occurred if the second flow sensor data indicates that more than 5 gallons (19 liters) of fluid has flowed past the second flow sensor after initiation of the filtration cycle. If the method determines that sufficient filtration has occurred (i.e., “YES” at 1444), the method 1400 can proceed to 1404. Otherwise, if the method determines that sufficient filtration has not occurred (i.e., “NO” at 1444), the method can proceed to 1440.

In some embodiments, a method for treating an inlet stream with a water treatment system may include supplying water to a membrane element, wherein the membrane element comprises a treated or processed NF membrane. The method may further include treating the NF membrane with one or more corrosive agents to intentionally tailor pore geometry and impart desired separation characteristics to the NF membrane. Representative separation characteristics tailored by the treatment step may include one or more of a calcium rejection percentage, total hardness rejection percentage, a TDS rejection percentage, an alkalinity rejection percentage, a permeate pH value, a membrane permeance value, a pollutant removal percentage, a permeate flow rate, and calculated LSI/CPP values (and/or other index values). In some cases, the values of the calcium rejection percentage, total hardness rejection percentage, a TDS rejection percentage, an alkalinity rejection percentage, a permeate pH value, a membrane permeance value, a pollutant removal percentage, a permeate flow rate, and calculated LSI/CPP values (and/or other index values) may be any of the values discussed with reference to those characteristics with respect to the water treatment system 100 of FIG. 1A.

In some embodiments, the method may further include removing micro-pollutants from the inlet feed stream. In some instances, the micro-pollutants may comprise PFAS compounds. Representative PFAS compounds that may be removed with the NF membrane may include perfluorobutane sulfonate (PFBS), perfluorohexanesulfonic acid (PFHxS), perfluorooctanoic acid (PFOA), perfluorooctane sulfonic acid (PFOS), perfluorodecanoic acid (PFDA), perfluoroheptanoic acid (PFHpA), and/or perfluorononanoic acid (PFNA). In certain cases, at least about 95%, or at least about 96%, or at least about 97%, or at least about 98%, or at least about 99%, or at least about 99.5%, or at least about 99.9%, or about 100% of total PFAS compounds present in the inlet water may be removed by the treated or processed NF membrane.

In some embodiments, the method may further include removing heavy metals from the inlet water. In some instances, the heavy metals may include, for example, copper, lead, arsenic, chromium, and iron. In certain cases, at least about 70%, or at least about 75%, or at least about 80%, or at least about 85%, or at least about 90%, or at least about 95%, or at least about 96%, or at least about 97%, or at least about 98%, or at least about 99%, or about 100% of the heavy metals in the inlet water may be removed from the inlet water by the treated or processed NF membrane.

In some embodiments, the method may include providing a permeate water from the membrane element. In some instances, the permeate water stream may be imparted with desired parameters or characteristics. For example, the permeate water may be imparted with a calcium ion concentration that is about 75% to about 90% less than a calcium ion concentration of the inlet water, a total hardness concentration that is about 75% to about 90% less than a total hardness concentration of the inlet water, a TDS level that is about 70% to about 90% less than the TDS level of the inlet water, an alkalinity value that is about 75% to about 90% less than the alkalinity value of the inlet water, and/or a pH level of about 6.2 to about 8.5. As an additional example, the permeate water may be imparted with a calcium ion concentration that is about 81% to about 84% less than a calcium ion concentration of the inlet water, a total hardness concentration that is about 81% to about 84% less than a total hardness concentration of the inlet water, a TDS level that is about 81% to about 84% less than the TDS level of the inlet water, an alkalinity value that is about 81% to about 84% less than the alkalinity value of the inlet water, and/or a pH level of about 6.8 to about 7.5. In some such instances, the membrane element may be treated, processed, or designed to have a desired membrane permeance of about 13 LMBH to about 20 LMBH, or about 17 LMBH to about 20 LMH/bar, although the desired membrane permeance may be greater than these values. In further such instances, the permeate water stream provided from the membrane element may be imparted with a flow rate of about 5 GPM to about 8 GPM, although the flow rate may be even greater than these values. As such, in various cases, the permeate water stream may be provided from the NF membrane as a balanced water stream.

It will be appreciated by those skilled in the art that while the above disclosure has been described above in connection with particular embodiments and examples, the above disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the above disclosure are set forth in the following claims.

1. A water treatment system, comprising:
a sediment filter for filtering untreated water in fluid communication with a source of the untreated water, wherein the untreated water enters the sediment filter and produces a first prefiltered water that exits the sediment filter;
a carbon filter for filtering the first prefiltered water and in fluid communication with the sediment filter, wherein the first prefiltered water enters the carbon filter and produces a second prefiltered water that exits the carbon filter;
an antiscalant feeder for adding an antiscalant to the second prefiltered water and in fluid communication with the carbon filter, wherein the second prefiltered water enters the antiscalant feeder and produces a third prefiltered water that exits the antiscalant feeder;
a pump in fluid communication with the antiscalant feeder;
a first membrane element for removing solutes from the third prefiltered water and in fluid communication with the pump, wherein the first membrane element produces a first permeate comprising the third prefiltered water imparted with a first concentration of solutes and a retentate comprising the third prefiltered water imparted with a second concentration of solutes, wherein the first concentration of solutes is less than the second concentration of solutes, the first membrane element in fluid communication with the pump;
a second membrane element for removing solutes from the retentate and in fluid communication with the first membrane element via a retentate line, wherein the second membrane element produces a second permeate;
a post-filtration subsystem comprising one or more mineralization cartridges in fluid communication with the first membrane element and the second membrane element via a permeate line, the post-filtration subsystem configured to add one or more minerals to the first permeate and the second permeate and produce mineralized water exiting the post-filtration subsystem; and
a tank in fluid communication with the post-filtration subsystem and the carbon filter, wherein the tank stores second prefiltered water from the carbon filter in a bottom portion of the tank and the mineralized water from the post-filtration subsystem in a top portion of the tank, the tank configured to supply an outlet with the mineralized water before the second prefiltered water.

2. The water treatment system of claim 1 further comprising:
one or more valves in fluid communication with one or more of the sediment filter, the carbon filter, the antiscalant feeder, the first membrane element, the second membrane element, and the post-filtration subsystem;
one or more sensors in fluid communication with one or more of the sediment filter, the carbon filter, the antiscalant feeder, the first membrane element, the second membrane element, and the post-filtration subsystem; and
a controller coupled to the one or more valves and the one or more sensors and configured to:
prompt, at a user interface, the user to install or replace one or more of the carbon filter, the antiscalant feeder, the first membrane element, the second membrane element, and the post-filtration subsystem;
control one or more of the one or more valves to perform a test;
receive test data from the one or more sensors;
determine that the test was successful based on the test data; and
output, at the user interface, an indication that the test was successful.

3. The water treatment system of claim 1 further comprising:
an indicator light;
one or more sensors in fluid communication with one or more of the sediment filter, the carbon filter, the antiscalant feeder, the first membrane element, the second membrane element, and the post-filtration subsystem; and
a controller coupled to the one or more sensors and configured to:
receive operational data from the one or more sensors;
determine if an error or warning has occurred; and
cause the indicator light to display a predetermined color based on the error or warning.

4. The water treatment system of claim 1 further comprising a second outlet coupled to the permeate line, the water treatment system configured to supply at least a portion of the first permeate and the second permeate to the outlet.

5. The water treatment system of claim 4 further comprising a valve coupled to the second outlet and the permeate line and configured to selectively supply the second outlet with at least a portion of the first permeate and the second permeate to the outlet.

6. The water treatment system of claim 1 further comprising a second outlet coupled to the tank, the tank configured to supply the outlet with the mineralized water before the second prefiltered water.

7. The water treatment system of claim 1 further comprising:
a conduit;
an indicator light;
one or more sensors in fluid communication with at least a portion of the conduit; and
a controller coupled to the one or more sensors and configured to:
receive operational data from the one or more sensors;
determine if an error or warning has occurred; and
cause the indicator light to display a predetermined color based on the error or warning.

8. The water treatment system of claim 1, wherein one or more of the first membrane element and the second membrane element are reverse osmosis membrane elements.

9. A water treatment system, comprising:
a sediment filter for filtering untreated water in fluid communication with a source of the untreated water, wherein the untreated water enters the sediment filter and produces a first prefiltered water that exits the sediment filter;
a carbon filter for filtering the first prefiltered water and in fluid communication with the sediment filter, wherein the first prefiltered water enters the carbon filter and produces a second prefiltered water that exits the carbon filter;
an antiscalant feeder for adding an antiscalant to the second prefiltered water and in fluid communication with the carbon filter, wherein the second prefiltered water enters the antiscalant feeder and produces a third prefiltered water that exits the antiscalant feeder;
a pump in fluid communication with the antiscalant feeder;
one or more membrane elements for removing solutes from the third prefiltered water and generating a permeate stream, the one or more membrane elements in fluid communication with the pump;
a post-filtration subsystem comprising one or more mineralization cartridges in fluid communication with the one or more membrane elements via a permeate line, the post-filtration subsystem configured to add one or more minerals to the permeate stream and produce mineralized water exiting the post-filtration subsystem; and
a tank in fluid communication with the post-filtration subsystem and the carbon filter, wherein the tank stores second prefiltered water from the carbon filter in a bottom portion of the tank and the mineralized water from the post-filtration subsystem in a top portion of the tank, the tank configured to supply an outlet with the mineralized water before the second prefiltered water.

10. The water treatment system of claim 9 further comprising:
one or more valves in fluid communication with one or more of the sediment filter, the carbon filter, the antiscalant feeder, the one or more membrane elements, and the post-filtration subsystem;
one or more sensors in fluid communication with one or more of the sediment filter, the carbon filter, the antiscalant feeder, the one or more membrane elements, and the post-filtration subsystem; and
a controller coupled to the one or more valves and the one or more sensors and configured to:
prompt, at a user interface, the user to install or replace one or more of the carbon filter, the antiscalant feeder, the one or more membrane elements, and the post-filtration subsystem;
control one or more of the one or more valves to perform a test;
receive test data from the one or more sensors;
determine that the test was successful based on the test data; and
output, at the user interface, an indication that the test was successful.

11. The water treatment system of claim 9 further comprising:
an indicator light;
one or more sensors in fluid communication with one or more of the sediment filter, the carbon filter, the antiscalant feeder, the one or more membrane elements, and the post-filtration subsystem; and
a controller coupled to the one or more sensors and configured to:
receive operational data from the one or more sensors;
determine if an error or warning has occurred; and
cause the indicator light to display a predetermined color based on the error or warning.

12. The water treatment system of claim 9 further comprising a second outlet coupled to the permeate line, the water treatment system configured to supply at least a portion of the permeate stream to the outlet.

13. The water treatment system of claim 12 further comprising a valve coupled to the second outlet and the permeate line and configured to selectively supply the second outlet with at least a portion of the permeate stream to the outlet.

14. The water treatment system of claim 9 further comprising a second outlet coupled to the tank, the tank configured to supply the outlet with the mineralized water before the second prefiltered water.

15. The water treatment system of claim 9 further comprising:
a conduit;
an indicator light;
one or more sensors in fluid communication with at least a portion of the conduit; and
a controller coupled to the one or more sensors and configured to:
receive operational data from the one or more sensors;
determine if an error or warning has occurred; and
cause the indicator light to display a predetermined color based on the error or warning.

16. The water treatment system of claim 9, wherein one or more of the one or more membrane elements are reverse osmosis membrane elements.

17. A water treatment system, comprising:
a sediment filter for filtering untreated water in fluid communication with a source of the untreated water, wherein the untreated water enters the sediment filter and produces a first prefiltered water that exits the sediment filter;
a carbon filter for filtering the first prefiltered water and in fluid communication with the sediment filter, wherein the first prefiltered water enters the carbon filter and produces a second prefiltered water that exits the carbon filter;
a pump in fluid communication with the carbon filter;
one or more membrane elements for removing solutes from the second prefiltered water and generating a permeate water, the one or more membrane elements in fluid communication with the pump; and
a tank in fluid communication with the post-filtration subsystem and the carbon filter, wherein the tank stores second prefiltered water from the carbon filter in a bottom portion of the tank and permeate water in a top portion of the tank, the tank configured to supply an outlet with the permeate water before the second prefiltered water.

18. The water treatment system of claim 17, wherein one or more of the one or more membrane elements are nanofiltration membrane elements.

19. The water treatment system of claim 17 further comprising a controller configured to:
prompt, at a user interface, the user to install or replace one or more of the sediment filter, the carbon filter, and one or more of the one or more membrane elements.

20. The water treatment system of claim 17 further comprising a controller configured to:
cause the water treatment system to perform a flush cycle of the one or more membrane elements using second prefiltered water and/or permeate water stored in the tank.
